(19) United States
(12) Patent Application Publication
(10) Pub. No.: US 2026/0143498 A1
(43) Pub. Date: May 21, 2026

(54) METHOD AND APPARATUS FOR PROCESSING PDCCH REPETITION TRANSMISSION, TERMINAL, AND NETWORK SIDE DEVICE

(71) Applicant: VIVO MOBILE COMMUNICATION CO., LTD., Dongguan (CN)

(72) Inventors: Wei JIANG, Dongguan (CN); Zhipeng LIN, Dongguan (CN); Yong WANG, Dongguan (CN)

(73) Assignee: VIVO MOBILE COMMUNICATION CO., LTD., Dongguan (CN)

(21) Appl. No.: 19/451,636

(22) Filed: Jan. 16, 2026

Related U.S. Application Data
(63) Continuation of application No. PCT/CN2024/104842, filed on Jul. 11, 2024.

(30) Foreign Application Priority Data
Jul. 18, 2023 (CN) 202310882204.1

(51) Int. Cl. H04W 72/23; H04W 72/0446

(52) U.S. Cl. CPC H04W 72/23; H04W 72/0446

(57) ABSTRACT

This application discloses a method and an apparatus for processing PDCCH repetition transmission, a terminal, and a network side device. The method for processing PDCCH repetition transmission in embodiments of this application includes: obtaining, by a terminal, configuration information of common PDCCH repetition transmission; and receiving, by the terminal, the common PDCCH repetition transmission based on the configuration information, where the common PDCCH includes at least one of the following: an SIB1 PDCCH, an OSI PDCCH, a message 2 PDCCH, a message 4 PDCCH, a message B PDCCH, a paging PDCCH, and a PDCCH for scheduling message 3 retransmission.

### CROSS-REFERENCE TO RELATED APPLICATIONS

This application is a continuation application of PCT International Application No. PCT/CN2024/104842 filed on Jul. 11, 2024, which claims priority to Chinese Patent Application No. 202310882204.1, filed on Jul. 18, 2023, which is incorporated herein by reference in its entirety.

### TECHNICAL FIELD

This application belongs to the field of communication technologies, and specifically, relates to a method and an apparatus for processing physical downlink control channel (PDCCH) repetition transmission, a terminal, and a network side device.

### BACKGROUND

In a terrestrial network scenario, link quality of a downlink channel is usually higher than that of an uplink channel because a transmit power of a base station is much higher than that of a terminal. However, in some application scenarios, for example, in a non-terrestrial communication network such as satellite communication, a downlink transmit power depends on a number of beams simultaneously supported by a satellite, and with the increase of the number of beams, a corresponding transmit power of each beam may decrease. For another example, in a high frequency situation, the transmit power of the base station may be close to that of a mobile phone, and the quality of the downlink channel is not necessarily higher than that of the uplink channel. In addition, the terminal (such as User Equipment, UE) uses a common physical downlink control channel (Common PDCCH) to send scheduling information of some common messages before establishment of a radio resource control (RRC) connection. If the quality of the downlink channel affects reception performance of the Common PDCCH, the common messages scheduled by the Common PDCCH cannot be received, and coverage performance of the network may be affected.

### SUMMARY

Embodiments of this application provide a method and an apparatus for processing PDCCH repetition transmission, a terminal, and a network side device.

According to a first aspect, a method for processing physical downlink control channel (PDCCH) repetition transmission is provided, including:
obtaining, by a terminal, configuration information of common PDCCH repetition transmission; and
receiving, by the terminal, the common PDCCH repetition transmission based on the configuration information, where
the common PDCCH includes at least one of the following:
a system information block (SIB) 1 PDCCH, an other system information (OSI) PDCCH, a message 2 PDCCH, a message 4 PDCCH, a message B PDCCH, a paging PDCCH, and a PDCCH for scheduling message 3 retransmission.

According to a second aspect, a method for processing physical downlink control channel (PDCCH) repetition transmission is provided, including:
sending, by a network side device, configuration information of common PDCCH repetition transmission to a terminal; and
performing, by the network side device, the common PDCCH repetition transmission based on the configuration information, where
the common PDCCH includes at least one of the following:
a system information block (SIB) 1 PDCCH, an OSI PDCCH, a message 2 PDCCH, a message 4 PDCCH, a message B PDCCH, a paging PDCCH, and a PDCCH for scheduling message 3 retransmission.

According to a third aspect, an apparatus for processing physical downlink control channel (PDCCH) repetition transmission is provided, including:
an obtaining module, configured to obtain configuration information of common PDCCH repetition transmission; and
a receiving module, configured to receive the common PDCCH repetition transmission based on the configuration information, where
the common PDCCH includes at least one of the following:
a system information block (SIB) 1 PDCCH, an OSI PDCCH, a message 2 PDCCH, a message 4 PDCCH, a message B PDCCH, a paging PDCCH, and a PDCCH for scheduling message 3 retransmission.

According to a fourth aspect, an apparatus for processing physical downlink control channel (PDCCH) repetition transmission is provided, including:
a sending module, configured to send configuration information of common PDCCH repetition transmission to a terminal; and
an execution module, configured to perform the common PDCCH repetition transmission based on the configuration information, where
the common PDCCH includes at least one of the following:
a system information block (SIB) 1 PDCCH, an OSI PDCCH, a message 2 PDCCH, a message 4 PDCCH, a message B PDCCH, a paging PDCCH, and a PDCCH for scheduling message 3 retransmission.

According to a fifth aspect, a terminal is provided. The terminal includes a processor and a memory, the memory stores a program or an instruction that can be run on the processor, and when the program or the instruction is executed by the processor, the steps of the method for processing PDCCH repetition transmission on a terminal side provided in an embodiment of this application are implemented.

According to a sixth aspect, a terminal is provided, including a processor and a communication interface, where the communication interface is configured to: obtain configuration information of common PDCCH repetition transmission; and receive the common PDCCH repetition transmission based on the configuration information, where the common PDCCH includes at least one of the following: a system information block (SIB) 1 PDCCH, an OSI PDCCH, a message 2 PDCCH, a message 4 PDCCH, a message B PDCCH, a paging PDCCH, and a PDCCH for scheduling message 3 retransmission.

According to a seventh aspect, a network side device is provided. The network side device includes a processor and a memory, the memory stores a program or an instruction that can be run on the processor, and when the program or the instruction is executed by the processor, the steps of the method for processing PDCCH repetition transmission on a network side provided in an embodiment of this application are implemented.

According to an eighth aspect, a network side device is provided, including a processor and a communication interface, where the communication interface is configured to send configuration information of common PDCCH repetition transmission to a terminal; and an execution module is configured to perform the common PDCCH repetition transmission based on the configuration information. The common PDCCH includes at least one of the following: a system information block (SIB) 1 PDCCH, an OSI PDCCH, a message 2 PDCCH, a message 4 PDCCH, a message B PDCCH, a paging PDCCH, and a PDCCH for scheduling message 3 retransmission.

According to a ninth aspect, a readable storage medium is provided. The readable storage medium stores a program or an instruction, and when the program or the instruction is executed by a processor, the steps of the method for processing PDCCH repetition transmission on a terminal side provided in an embodiment of this application are implemented, or the steps of the method for processing PDCCH repetition transmission on a network side provided in an embodiment of this application are implemented.

According to a tenth aspect, a wireless communication system is provided, including a terminal and a network side device. The terminal may be configured to perform the steps of the method for processing PDCCH repetition transmission on a terminal side provided in an embodiment of this application, and the network side device may be configured to perform the steps of the method for processing PDCCH repetition transmission on a network side provided in an embodiment of this application.

According to an eleventh aspect, a chip is provided. The chip includes a processor and a communication interface, the communication interface is coupled to the processor, and the processor is configured to run a program or an instruction to implement the method for processing PDCCH repetition transmission on a terminal side provided in an embodiment of this application or the method for processing PDCCH repetition transmission on a network side provided in an embodiment of this application.

According to a twelfth aspect, a computer program/program product is provided. The computer program/program product is stored in a storage medium, and the program/program product is executed by at least one processor to implement the steps of the method for processing PDCCH repetition transmission on a terminal side provided in an embodiment of this application, or the program/program product is executed by at least one processor to implement the steps of the method for processing PDCCH repetition transmission on a network side provided in an embodiment of this application.

### BRIEF DESCRIPTION OF DRAWINGS

FIG. 1 is a block diagram of a wireless communication system to which embodiments of this application are applicable;

FIG. 2 is a flowchart of a method for processing PDCCH repetition transmission according to an embodiment of this application;

FIG. 3 is a flowchart of another method for processing PDCCH repetition transmission according to an embodiment of this application;

FIG. 4 is a structural diagram of an apparatus for processing PDCCH repetition transmission according to an embodiment of this application;

FIG. 5 is a structural diagram of another apparatus for processing PDCCH repetition transmission according to an embodiment of this application;

FIG. 6 is a structural diagram of a communication device according to an embodiment of this application;

FIG. 7 is a structural diagram of a terminal according to an embodiment of this application; and

FIG. 8 is a structural diagram of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this application, “or” indicates at least one of connected objects. For example, “A or B” covers three solutions, namely, solution 1: including A and not including B; solution 2: including B and not including A; and solution 3: including A and B. A character “/” generally indicates an “or” relationship between the associated objects.

The term “indication” in this application may be either a direct indication (or referred to as an explicit indication) or an indirect indication (or referred to as an implicit indication). The direct indication can be understood as that a sender clearly informs a receiver of specific information, an operation required to be performed, a request result, or the like in a sent indication; and the indirect indication can be understood as that the receiver determines corresponding information based on an indication sent by the sender, or makes a determination and determines the operation required to be performed, the request result, or the like based on a determination result.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or other systems. The terms “system” and “network” in the embodiments of this application may be used interchangeably. The technologies described can be applied to both the systems and the radio technologies mentioned above as well as to other systems and radio technologies. The following descriptions describe a new radio (NR) system for example purposes, and NR terms are in most of the following descriptions, but these technologies can also be applied to a system other than the NR system, for example, a 6th generation (6G) communication system.

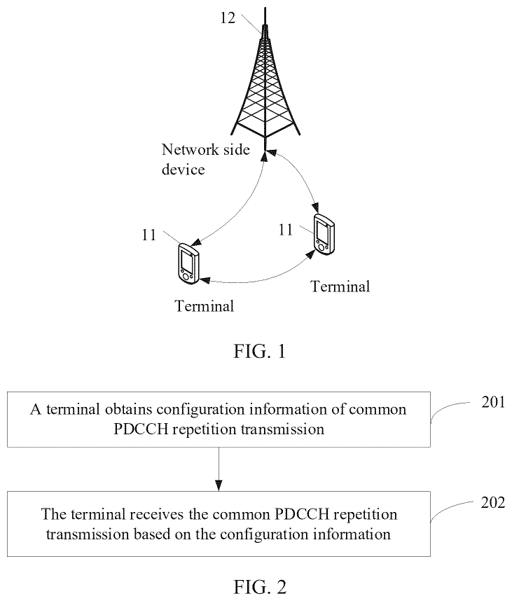

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, a flight vehicle, vehicle user equipment (VUE), ship-borne equipment, pedestrian user equipment (PUE), smart household devices (household devices with wireless communication functions, such as a refrigerator, a television, a washing machine, or furniture), a game console, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (Wi-Fi) node, and the like. The base station may be referred to as a NodeB (NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. As long as a same technical effect is achieved, the base station is not limited to a specified technical term. It should be noted that, in the embodiments of this application, only a base station in an NR system is used as an example for description, but a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), unified data repository (UDR), a home subscriber server (HSS), centralized network configuration (CNC), a network repository function (NRF), a network exposure function (NEF), a local NEF (L-NEF), a binding support function (BSF), an application function (AF), and the like. It should be noted that, in the embodiments of this application, only a core network device in an NR system is used as an example for description, and a specific type of the core network device is not limited.

In some embodiments, a random access procedure may be a contention-based random access procedure, or may be a non-contention-based random access procedure. The random access procedure may be a 4-step random access channel procedure (also referred to as a Type-1 random access channel procedure) or may be a 2-step random access channel procedure (also referred to as a Type-2 random access channel procedure).

In a contention-based 4-step random access channel (RACH) procedure, a terminal first sends, to a network, message 1 (Msg1) including a preamble; after detecting the preamble, the network may send message 2 (Msg2)/a random access response (RAR) message, including an identifier of the preamble detected by the network and an uplink radio resource allocated to the terminal for sending message 3 (Msg3); after receiving Msg2, the terminal confirms that at least one identifier of the preamble carried in Msg2 is consistent with an identifier of the preamble sent by the terminal, and sends, based on a resource indicated by RAR, Msg3 including contention resolution information; after receiving Msg3, the network may send message 4 (Msg4) including the contention resolution information; and when receiving Msg4, the terminal confirms that the contention resolution information is consistent with that sent by the terminal in Msg3. In this way, 4-step random access is completed.

The network includes uplink grant (UL grant) information in RAR for indicating scheduling information of a Msg3 physical uplink shared channel (PUSCH), and includes information such as a random access channel preamble identifier (RACH preamble ID, RAPID), a temporary cell-radio network temporary identifier (TC-RNTI), and timing advance (TA). If not receiving the Msg3 PUSCH, the network may schedule retransmission of the Msg3 PUSCH in a physical downlink control channel (PDCCH) scrambled by TC-RNTI.

For the contention-based random access procedure, different terminals randomly select a preamble for transmission, so different terminals may select a same preamble for transmission on a same time-frequency radio resource (such as a random access channel occasion (RO) resource). This case can be understood as a preamble conflict of terminals. In this case, different terminals may receive a same RAR, and different terminals may transmit Msg3 PUSCH based on scheduling information in the RAR UL grant. In some related technologies, because repetition transmission of Msg3 PUSCH is not supported, the network can solve, on one Msg3 PUSCH scheduling resource, a PUSCH (including contention resolution information) sent by only one terminal, so the network may include, in Msg4, the contention resolution information received in Msg3. If the contention resolution information received by the terminal in Msg4 matches the contention resolution information sent by the terminal in Msg3 PUSCH, the terminal considers that contention resolution is successful. If the contention resolution information received by the terminal in Msg4 does not match the contention resolution information sent by the terminal in Msg3 PUSCH, it is considered that the contention resolution is unsuccessful.

If the contention resolution is unsuccessful, the terminal reselects a RACH transmission resource for physical random access channel (PRACH) transmission, and performs a next random access attempt.

In some embodiments, a first step in the 2-step random access channel (2-step RACH) procedure is that the terminal sends message A (MsgA) to a network side. After receiving MsgA, the network side sends message B (MsgB) to the terminal. If the terminal does not receive MsgB within a period of time, the terminal may increment a counter for counting a number of MsgA transmissions and resend MsgA. If the counter for counting the number of MsgA transmissions reaches a threshold, the terminal may switch from the 2-step random access channel procedure to the 4-step random access channel procedure. MsgA includes a MsgA preamble part and a MsgA PUSCH part. The preamble part is sent on an RO for the 2-step random access channel procedure, and the PUSCH part is sent on a MsgA PUSCH resource associated with sending the MsgA preamble and the RO. The MsgA PUSCH resource is a set of PUSCH resources configured for each PRACH slot, including a time-frequency resource and a DMRS resource.

In some embodiments, CORESET is a collection of time domain and frequency domain resources of control information. CORESET #0 is a special CORESET, and is usually used for transmission of a PDCCH scheduling a system information block (SIB) 1. Configuration information of CORESET #0 and configuration information of a monitoring occasion of Type0-PDCCH common search space (CSS) are carried by an associated cell defining synchronization signal block (CD-SSB). A main function of CORESET #0 is to define a time and a frequency resource of Type0-PDCCH CSS, and duration of the monitoring occasion of Type0-PDCCH CSS.

In some embodiments, CORESET #0 and a synchronization signal block (SSB) have the following multiplexing modes.

Multiplexing mode 1: it is a multiplexing mode in which SSB and CORESET #0 appear at different moments (no overlap in time domain), and a transmission bandwidth of SSB and an initial active downlink bandwidth part (BWP) of CORESET #0 overlap (overlap in frequency domain); and it may be used when a carrier frequency is less than 6 GHz or greater than 6 GHZ (and less than 52.6 GHz).

Multiplexing mode 2: it is a multiplexing mode in which SSB and CORESET #0 appear at different moments (no overlap in time domain), and a transmission bandwidth of SSB and an initial active downlink BWP of CORESET #0 do not overlap (no overlap in frequency domain); and SSB is located at the top or bottom of CORESET #0. It is used only when a carrier frequency is greater than 6 GHz. SSB is located at the top of CORESET #0 with an offset of 12+k_{SSB} subcarriers. SSB is located at the bottom of CORESET #0, and if k_{SSB} is equal to 0, there is an offset of 12 subcarriers; and if k_{SSB} is not equal to 0, there is an offset of 24-k_{SSB} subcarriers.

Multiplexing mode 3: it is a multiplexing mode in which SSB and CORESET #0 appear at a same moment (overlap in time domain), and a transmission bandwidth of SSB and an initial active downlink BWP of CORESET #0 do not overlap (no overlap in frequency domain); and SSB is located at the top or bottom of CORESET #0. It is used only when a carrier frequency is greater than 6 GHz. SSB is located at the top of CORESET #0 with an offset of k_{SSB} subcarriers. SSB is located at the bottom of CORESET #0, and if k_{SSB} is equal to 0, there is an offset of 0 subcarriers; and if k_{SSB} is not equal to 0, there is an offset of 12-k_{SSB} subcarriers.

In some embodiments, there are two types of search space (SS) sets: a common search space (CSS) set monitored by a group of terminals in a cell, and a UE-specific search space (USS) set monitored by a single terminal. The SS set further configures, for the terminal, PDCCH candidates that need to be monitored (monitoring) by the terminal. The search space can be classified into the following types:
1. Type0-PDCCH common search space set (CSS set): the search space set is used for monitoring SIB1 system message;
2. Type0A-PDCCH CSS set: the search space set is used for monitoring system messages other than SIB1;
3. Type1-PDCCH CSS set: the search space set is used for monitoring: a downlink PDCCH corresponding to Msg2/Msg4 in a conventional 4-step random access channel procedure; and a downlink PDCCH corresponding to MsgB in the 2-step random access channel procedure;
4. Type2-PDCCH CSS set: the search space set is used for monitoring a paging (paging) message;
5. Type3-PDCCH CSS set: the search space set is used for monitoring an uplink power control PDCCH, a downlink pre-emption PDCCH, a slot format indication PDCCH, and a PDCCH related to downlink data transmission; and
6. USS: the search space set is used for monitoring a PDCCH related to downlink data transmission.

In some embodiments, in a random access procedure, reception of scheduling information for scheduling Msg2/MsgB/Msg4 physical downlink shared channel (PDSCH) needs to be within a window, and a size of the window is configured by the network.

For Msg2, the foregoing window starts from a 1^{st} symbol of a 1^{st} control resource set (CORESET) in Type1-PDCCH common search space set (Type1-PDCCH CSS set) after the PRACH transmission. For MsgB, the foregoing window starts from a 1^{st} symbol of a 1^{st} CORESET in Type1-PDCCH CSS set after a PUSCH (MsgA PUSCH part) resource corresponding to the PRACH (MsgA PRACH part) transmission.

For Msg4, the window is actually controlled by a random access contention resolution timer (ra-ContentionResolutionTimer), and the timer may start or restart after sending Msg3 (a last transmission of sending Msg3 if Msg3 repetition transmission is supported).

With reference to the accompanying drawings, the following describes in detail a method and an apparatus for processing PDCCH repetition transmission, a terminal, and a network side device provided in the embodiments of this application by using some embodiments and application scenarios thereof.

Referring to FIG. 2, FIG. 2 is a flowchart of a method for processing PDCCH repetition transmission according to an embodiment of this application. As shown in FIG. 2, the method includes the following steps.

Step 201: Obtain configuration information of common PDCCH repetition transmission.

Step 202: The terminal receives the common PDCCH repetition transmission based on the configuration information.

The common PDCCH includes at least one of the following:
a system information block (SIB) 1 physical downlink control channel (PDCCH), an other system information (OSI) PDCCH, a message 2 (Msg2) PDCCH, a message 4 (Msg4) PDCCH, a message B (MsgB) PDCCH, a paging PDCCH, and a PDCCH for scheduling message 3 (Msg3) retransmission.

The SIB1 PDCCH refers to a PDCCH scheduling SIB1, the OSI PDCCH refers to a PDCCH scheduling OSI, the Msg2 PDCCH refers to a PDCCH scheduling Msg2, the Msg4 PDCCH refers a PDCCH scheduling Msg4, the MsgB PDCCH refers to a PDCCH scheduling MsgB, and the paging PDCCH refers to a PDCCH scheduling paging or a PDCCH used for paging.

The common PDCCH may refer to one or more types of PDCCH transmitted on a common PDCCH resource, the common PDCCH resource may be a CORESET resource supporting CSS, CORESET #0, or another CORESET, and the CSS may include at least one of the following:

Type0 CSS set, Type0A CSS set, Type1 CSS set, and Type2 CSS set.

For example, the common PDCCH may be a PDCCH transmitted on CORESET #0, or may be a PDCCH transmitted on a CORESET resource associated with the Type0/0A/1/2 PDCCH CSS set.

In addition, the common PDCCH transmitted on the CORESET resource associated with CSS is also referred to as a broadcast PDCCH.

In addition, the common PDCCH may be a common PDCCH in a non-terrestrial network (NTN) scenario or a common PDCCH in a terrestrial network (TN) scenario.

In some implementations, the common PDCCH may also be a PDCCH before the terminal enters an RRC connection state.

In this embodiment of this application, common PDCCH repetition transmission may also be referred to as common PDCCH repetition, or each transmission of common PDCCH repetition transmission is referred to as a PDCCH repetition.

The configuration information of the common PDCCH repetition transmission may be information such as a function, a number, and a pattern of the common PDCCH repetition transmission, or the configuration information of the common PDCCH repetition transmission may be timeline information of the common PDCCH repetition transmission.

In this embodiment of this application, through the foregoing steps, the terminal can receive the common PDCCH repetition transmission, thereby improving coverage performance of the network. Furthermore, because the common PDCCH includes an SIB1 PDCCH, an OSI PDCCH, a message 2 PDCCH, a message 4 PDCCH, a message B PDCCH, a paging PDCCH, and a PDCCH for scheduling message 3 retransmission, the terminal can better receive a message in a random access procedure, to improve random access performance of the terminal.

In an optional implementation, the configuration information includes at least one of the following parameters:
a function of the common PDCCH repetition transmission;
a number of repetitions of the common PDCCH repetition transmission;
an index of the common PDCCH repetition transmission;
resource information of the common PDCCH repetition transmission;
activation information of the common PDCCH repetition transmission, the activation information representing activation or deactivation of the common PDCCH repetition transmission; and
a repetition mode of the common PDCCH repetition transmission.

The function of the common PDCCH repetition transmission may indicate whether a network side supports the common PDCCH repetition transmission or whether a network side device supports a terminal in requesting the common PDCCH repetition transmission; and the function of the common PDCCH repetition transmission may indicate whether a terminal supports the common PDCCH repetition transmission or whether the terminal supports requesting the common PDCCH repetition transmission from a network side device.

The index of the common PDCCH repetition transmission may indicate an ordinal number of the common PDCCH repetition transmission, such as an n^{th} transmission, and a value of n is greater than or equal to 1 and less than or equal to the number of repetitions of the common PDCCH repetition transmission.

The resource information of the common PDCCH repetition transmission may include at least one of the following:
a pattern of the common PDCCH repetition transmission, the pattern indicating a resource location occupied by the common PDCCH repetition transmission;
indication information for indicating that the common PDCCH repetition transmission is performed based on an available slot; and
indication information for indicating that the common PDCCH repetition transmission is performed based on a physical slot.

The pattern of the common PDCCH repetition transmission may represent a control channel element (CCE) location or a PDCCH candidatelocation. For example, in a case of supporting inter-CORESET PDCCH repetition transmission, the pattern may indicate whether CCE locations occupied by different PDCCH repetitions (namely, different transmissions) in different CORESETs or PDCCH candidate locations are the same or follow a variation mode, or in a case of supporting intra-CORESET PDCCH repetition transmission, the pattern may indicate whether CCE locations occupied by different PDCCH repetitions (namely, different transmissions) in a same CORESET or PDCCH candidate locations are the same or follow a variation mode.

The indication information for indicating that the common PDCCH repetition transmission is performed based on an available slot may indicate whether repetition transmission of the common PDCCH is performed based on the available slot.

The indication information for indicating that the common PDCCH repetition transmission is performed based on a physical slot may indicate whether repetition transmission of the common PDCCH is performed based on the physical slot.

The repetition mode of the common PDCCH repetition transmission may include at least one of the following:
intra-slot repetition transmission (intra-slot repetition); and
inter-slot repetition transmission (inter-slot repetition).

The intra-slot repetition transmission may be that all transmissions of the common PDCCH repetition transmission are completed in one slot. For example, with reference to a manner of adding a column in Table 1 described below, a 1^{st} symbol index (First symbol index) indicates a starting symbol, and a number of symbols (Number of Symbols) indicates a number of symbols occupied in each transmission. In addition, a single transmission cannot be performed across slot. For example, when First symbol index=0, and Number of Symbols=3, PDCCH repetition index 0 is on symbol 0/1/2, PDCCH repetition index 1 is on symbol 3/4/5, PDCCH repetition index 2 is on symbol 6/7/8, PDCCH repetition index 3 is on symbol Sep. 10, 2011, and because a number of remaining two symbols is less than Number of Symbols: 3, there is no PDCCH repetition index 4.

The inter-slot repetition transmission may be that each transmission of the common PDCCH repetition transmission is completed in one slot. For example, with reference to the manner of adding a column in Table 1 described below, each slot uses same First symbol index and Number of symbols. The number of repetitions determines a number of consecutive slots for repetition transmission.

In the foregoing implementation, the terminal can better receive the common PDCCH repetition transmission of the network side device by using the configuration information, to further improve reliability of PDCCH reception.

In an optional implementation, the obtaining, by a terminal, configuration information of common PDCCH repetition transmission includes:

determining, by the terminal, the configuration information of the common PDCCH repetition transmission based on indication information, the indication information including at least one of the following:

an SSB, a master information block (MIB), a physical broadcast channel (PBCH), an SIB, a radio network temporary identifier (RNTI), a CORESET configuration table, a monitoring occasion table of a CSS, a downlink channel receiving window, a downlink channel transmission period, a CORESET resource, a search space, a PDCCH MO, a physical random access channel (PRACH) resource, an SIB1 PDCCH, Msg2, MsgB, a Msg2 PDCCH, a MsgB PDCCH, a PDCCH for scheduling Msg3 retransmission, radio resource control (RRC) signaling, a medium access control control element (MAC CE), a random access response, downlink control information (DCI), and Msg3.

The indication information is indication information received by the terminal from the network side device.

In the foregoing implementation, the configuration information may be indicated by using at least one of the above items, so that no additional message is required to be introduced, thereby reducing transmission overheads.

In some implementations, the configuration information is configuration information explicitly or implicitly indicated by the indication information.

For example, the configuration information is indicated implicitly or explicitly by using an SSB or an MIB.

In some implementations, the configuration information is implicitly indicated by using some bits in an existing field in the MIB. For example, the configuration information is implicitly indicated by using a specific value (a subcarrier offset value between subcarrier 0 of the SSB and subcarrier 0 in a common resource block) of k_{SSB} in the MIB, such as defining values or groups of k_{SSB} corresponding to different numbers of repetitions. For example, when the value of k_{SSB} is 0 to 1, it indicates that the common PDCCH repetition transmission is not supported; when the value of k_{SSB} is 2 to 3, it indicates that the common PDCCH repetition transmission is supported, and the number of repetitions of the common PDCCH repetition transmission is 2; and when the value of k_{SSB} is 4 to 5, it indicates that the common PDCCH repetition transmission is supported, and the number of repetitions of the common PDCCH repetition transmission is 4. Alternatively, the configuration information is explicitly carried in MIB information, such as using spare bits in the MIB.

Alternatively, the configuration information is indicated implicitly or explicitly by using a PBCH, or the configuration information is indicated by using an SIB. The SIB includes SIB1 or other system information (OSI), for example, the configuration information is indicated to be carried explicitly through signaling of one or more bits in the SIB, or the configuration information is carried through PDCCH common configuration (PDCCH-configCommon) signaling.

Alternatively, it is indicated by using a specific PRACH resource, for example, when the network is configured with a PRACH resource for the terminal to request common PDCCH repetition or for the terminal to report a capability of receiving PDCCH repetition, it indicates that the network supports a common PDCCH repetition function.

In some implementations, the indication information includes the PBCH, and the determining, by the terminal, the configuration information of the common PDCCH repetition transmission based on indication information includes:
determining at least some parameters in the configuration information of the common PDCCH repetition transmission based on at least one of a demodulation reference signal (DMRS) sequence of the PBCH, a DMRS pattern of the PBCH, a DMRS time domain resource of the PBCH, a DMRS frequency domain resource of the PBCH, a scrambling sequence of the PBCH, and a payload of the PBCH (PBCH payload).

There is no need to introduce additional overheads when indicating the configuration information through at least one of the following in the PBCH, thereby reducing signaling overheads.

For example, generation of a DMRS sequence is related to the configuration information of Common PDCCH repetition, for example, parameters used in initialization of a DMRS sequence include the number of repetitions of Common PDCCH repetition.

For another example, generation of the scrambling sequence is related to the configuration information of Common PDCCH repetition, for example, parameters used in initialization of the scrambling sequence include the number of repetitions of Common PDCCH repetition.

For another example, it is explicitly carried in the PBCH payload, for example, the number of repetitions of Common PDCCH repetition is explicitly indicated in layer 1 payload (L1 payload) of the PBCH.

In some implementations, the downlink channel receiving window may include a window corresponding to at least one of the following:
a random access response window (RAR window);
a contention resolution timer; and
a message B-response window (MsgB response window).

The downlink channel transmission period may include:
an association period between an SSB and a random access channel occasion (RO);
an SSB period;
an SIB1 period; and
a period of a search space.

In some implementations, the RNTI includes a first RNTI defined for the common PDCCH repetition transmission, and the first RNTI is used for scrambling DCI related to the common PDCCH.

The RNTI defined for the common PDCCH repetition transmission can be understood as a newly defined RNTI for the common PDCCH repetition transmission.

A generation manner of the first RNTI may include: being generated based on a second RNTI and an offset. For example, the generation manner of the first RNTI may include at least one of the following:

being generated based on a random access radio network temporary identifier (RA-RNTI) and an offset;
being generated based on a system information radio network temporary identifier (SI-RNTI) and an offset;
being generated based on a temporary cell radio network temporary identifier (TC-RNTI) and an offset;
being generated based on a paging radio network temporary identifier (P-RNTI) and an offset; and
being generated based on a message B radio network temporary identifier (MsgB-RNTI) and an offset, where
the offset is associated with the configuration information of the common PDCCH repetition transmission.

That the offset is associated with the configuration information of the common PDCCH repetition transmission can be understood as that the offset is used for indicating the configuration information of the common PDCCH repetition transmission, for example, different values/ranges of the offset correspond to different functions/numbers of Common PDCCH repetition.

In the foregoing implementation, indication of the repetition information is realized by using the RNTI and the offset, so that no additional message is required to be introduced, thereby reducing transmission overheads.

Optionally, the CORESET configuration table includes a first CORESET configuration table, the first CORESET configuration table is a CORESET resource configuration table for a type0-PDCCH search space set, and different resource configurations in the first CORESET configuration table correspond to respective configuration parameters of common PDCCH repetition transmission; or the CORESET configuration table includes a second CORESET configuration table, the second CORESET configuration table is a CORESET resource configuration table defined for the common PDCCH repetition transmission, and different indexes in the second CORESET configuration table correspond to respective configuration parameters of common PDCCH repetition transmission, where the configuration parameters of the common PDCCH repetition transmission are at least some parameters included in the configuration information of the common PDCCH repetition transmission;
or
the monitoring occasion table of the CSS includes a monitoring occasion table of a first CSS, the monitoring occasion table of the first CSS is a PDCCH monitoring occasion table for a type0-PDCCH search space set, and parameters of different PDCCH monitoring occasions in the monitoring occasion table of the first CSS correspond to respective configuration parameters of common PDCCH repetition transmission; or the monitoring occasion table of the CSS includes a monitoring occasion table of a second CSS, the monitoring occasion table of the second CSS is a CSS monitoring occasion table defined for the common PDCCH repetition transmission, and different indexes in the monitoring occasion table of the second CSS correspond to respective configuration parameters of common PDCCH repetition transmission, where the configuration parameters of the common PDCCH repetition transmission are at least some parameters included in the configuration information of the common PDCCH repetition transmission.

The configuration parameters may include at least one of the following:
a function of the common PDCCH repetition transmission;
a number of repetitions of the common PDCCH repetition transmission;
an index of the common PDCCH repetition transmission;
resource information of the common PDCCH repetition transmission;
activation information of the common PDCCH repetition transmission; and
a repetition mode of the common PDCCH repetition transmission.

In some embodiments, the first CORESET configuration table may be a CORESET resource configuration table defined in a protocol for the type0-PDCCH search space set, for example, table 1 below.

TABLE 1

| | SS/PBCH | | | | |
|---|---|---|---|---|---|
| | block and | | | | |
| | CORESET | Number of | Number of | | |
| | multiplexing | RBs | symbols | Offset | Number of |
| Index | mode | N_{RB}^{CORESET} | N_{symb}^{CORESET} | (RBs) | repetitions |
| 0 | 1 | 24 | 2 | 0 | 6 |
| 1 | 1 | 24 | 2 | 2 | 6 |
| 2 | 1 | 24 | 2 | 4 | 6 |
| 3 | 1 | 24 | 3 | 0 | 4 |
| 4 | 1 | 24 | 3 | 2 | 4 |
| 5 | 1 | 24 | 3 | 4 | 4 |
| 6 | 1 | 48 | 1 | 12 | 12 |
| 7 | 1 | 48 | 1 | 16 | 12 |
| 8 | 1 | 48 | 2 | 12 | 6 |
| 9 | 1 | 48 | 2 | 16 | 6 |
| 10 | 1 | 48 | 3 | 12 | 4 |
| 11 | 1 | 48 | 3 | 16 | 4 |
| 12 | 1 | 96 | 1 | 38 | 12 |
| 13 | 1 | 96 | 2 | 38 | 6 |
| 14 | 1 | 96 | 3 | 38 | 4 |

| | |
|---|---|
| 15 | Reserved |

The SS/PBCH block and CORESET multiplexing mode, the number of RBs, the number of symbols, and the offset in Table 1 are resource configurations, and the number of repetitions is the configuration parameter of the PDCCH repetition transmission. Table 1 may show a relationship between these resource configurations and the configuration parameter of the PDCCH repetition transmission.

A last column in Table 1 is a newly added column. Table 1 may indicate a resource block and a slot symbol set of CORESET used for the type0-PDCCH search space set, and may be specifically applied to a band scenario in which subcarrier spacings (SCS) corresponding to the SSB and the PDCCH are both 15 kHz, and a minimum channel bandwidth is 5 MHz or 10 MHz.

What is added to the first CORESET configuration table to indicate some or all parameters in the configuration information may be adding a new column to the first CORESET configuration table, for example, a column is added to the first CORESET configuration table indicated by a 4 bit most significant bit (MSB) in an SIB1 PDCCH configuration (PDCCH-configSIB1), to indicate whether the common PDCCH performs repetition transmission, a number of repetitions, a repetition index, a pattern of repetition transmission, or the like.

In Table 1, an example in which the configuration parameter is the number of repetitions is used for description.

In the foregoing implementation, the configuration parameter of the PDCCH repetition transmission may be indicated through the resource configuration in the first CORESET configuration table, thereby reducing configuration overheads.

The second CORESET configuration table may be a CORESET resource configuration table defined for the common PDCCH repetition transmission, for example, the second CORESET configuration table is a newly defined CORESET resource configuration table for the common PDCCH repetition transmission.

In some implementations, the second CORESET configuration table is a CORESET resource configuration table determined based on a condition defined in a protocol and a condition defined for the common PDCCH repetition transmission.

The condition defined in a protocol may be a condition corresponding to the first CORESET configuration table, for example, SCSs corresponding to the SSB and the PDCCH are both 15 kHz, and the minimum channel bandwidth is 5 MHz or 10 MHz.

The condition defined for the common PDCCH repetition transmission may be a newly defined condition for the common PDCCH repetition transmission, for example, including at least one of the following:
a specific value of k_{SSB}, a specific system frame number, and a spare bit in the MIB.

In the foregoing implementation, the index in the second CORESET configuration table is used to indicate the configuration parameter of the PDCCH repetition transmission, so that the configuration parameter may be indicated more flexibly.

In some implementations, the monitoring occasion table of the first CSS is a PDCCH monitoring occasion table defined in a protocol for the type0-PDCCH search space set, which can be understood as that the monitoring occasion table of the first CSS is a PDCCH monitoring occasion table that has been defined in a protocol for the type0-PDCCH search space set, for example, as shown in Table 2 below.

TABLE 2

| | | Number of | | | |
|---|---|---|---|---|---|
| | | search space sets | | | |
| Index | O | in each slot | M | 1^{st} symbol index | Number of repetitions |
| 0 | 0 | 1 | 1 | 0 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 1 | 0 | 2 | 1/2 | {0, if i is even}, | $\{ 6 , if {N}_{s y m b}^{CORESET} is 1 \} ,$ |
| | | | | $\{ {N}_{s y m b}^{CORESET} , if i is$ | $\{ 3 , if {N}_{s y m b}^{CORESET} is 2 \} ,$ |
| | | | | odd} | $\{ 2 , if {N}_{s y m b}^{CORESET} is 3 \}$ |
| 2 | 2 | 1 | 1 | 0 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 3 | 2 | 2 | 1/2 | {0, if i is even}, | $\{ 6 , if {N}_{s y m b}^{CORESET} is 1 \} ,$ |
| | | | | $\{ {N}_{s y m b}^{CORESET} , if i is$ | $\{ 3 , if {N}_{s y m b}^{CORESET} is 2 \} ,$ |
| | | | | odd} | $\{ 2 , if {N}_{s y m b}^{CORESET} is 3 \}$ |
| 4 | 5 | 1 | 1 | 0 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 5 | 5 | 2 | 1/2 | {0, if i is even}, | $\{ 6 , if {N}_{s y m b}^{CORESET} is 1 \} ,$ |
| | | | | $\{ {N}_{s y m b}^{CORESET} , if i is$ | $\{ 3 , if {N}_{s y m b}^{CORESET} is 2 \} ,$ |
| | | | | odd} | $\{ 2 , if {N}_{s y m b}^{CORESET} is 3 \}$ |
| 6 | 7 | 1 | 1 | 0 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 7 | 7 | 2 | 1/2 | {0, if i is even}, | $\{ 6 , if {N}_{s y m b}^{CORESET} is 1 \} ,$ |
| | | | | $\{ {N}_{s y m b}^{CORESET} , if i is$ | $\{ 3 , if {N}_{s y m b}^{CORESET} is 2 \} ,$ |
| | | | | odd} | $\{ 2 , if {N}_{s y m b}^{CORESET} is 3 \}$ |
| 8 | 0 | 1 | 2 | 0 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 9 | 5 | 1 | 2 | 0 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 10 | 0 | 1 | 1 | 1 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 11 | 0 | 1 | 1 | 2 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 12 | 2 | 1 | 1 | 1 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 13 | 2 | 1 | 1 | 2 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 14 | 5 | 1 | 1 | 1 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |
| 15 | 5 | 1 | 1 | 2 | $\{ 12 , if {N}_{s y m b}^{CORESET} is 1 \} ,$ |
| | | | | | $\{ 6 , if {N}_{s y m b}^{CORESET} is 2 \} ,$ |
| | | | | | $\{ 4 , if {N}_{s y m b}^{CORESET} is 3 \}$ |

O (an index of a 1^{st} OFDM symbol in the search space), the number of search space sets in each slot, M (a number of search spaces in each slot), and the 1^{st} symbol index in Table 2 are resource configurations, and the number of repetitions is the configuration parameter of the PDCCH repetition transmission. Table 2 may show a relationship between these resource configurations and the configuration parameter of the PDCCH repetition transmission.

A last column in Table 2 is a newly added column. Table 2 may use SSB/PBCH and CORESET repetition pattern 1, and is in a scenario of frequency range (FR) 1. In Table 2, indicating the number of repetitions is used as an example for description.

What is added to the monitoring occasion table of the first CSS to indicate some or all parameters in the configuration information may be adding a new column to the monitoring occasion table of the first CSS, for example, a column is added to the monitoring occasion table of the first CSS indicated by a 4 bit least significant bit (LSB) in PDCCH-configSIB1, to indicate whether the common PDCCH performs repetition transmission, a number of repetitions, a repetition index, a pattern of repetition transmission, or the like.

In the foregoing implementation, the configuration parameter of the PDCCH repetition transmission may be indicated by using a parameter of the PDCCH monitoring occasion in the monitoring occasion table of the first CSS, thereby reducing configuration overheads.

The monitoring occasion table of the second CSS may be a monitoring occasion table of a CSS defined for the common PDCCH repetition transmission, for example, the monitoring occasion table of the second CSS is a newly defined monitoring occasion table of a CSS for the common PDCCH repetition transmission.

In some implementations, the monitoring occasion table of the second CSS is a monitoring occasion table of a CSS determined based on a condition defined in a protocol and a condition defined for the common PDCCH repetition transmission.

The condition defined in a protocol may be a condition corresponding to the monitoring occasion table of the first CSS, such as SSB/PBCH and CORESET repetition pattern 1, and being in FR1.

The condition defined for the common PDCCH repetition transmission may be a newly defined condition for the common PDCCH repetition transmission, for example, including at least one of the following:
a specific value of k_{SSB}, a specific system frame number, and a spare bit in the MIB.

In the foregoing implementation, the index in the monitoring occasion table of the second CSS is used to indicate the configuration parameter of the PDCCH repetition transmission, so that the configuration parameter may be indicated more flexibly.

Optionally, a number of resources existing in the downlink channel receiving window is associated with some or all parameters in the configuration information, and the number of resources includes at least one of the following: a number of CORESETs, a number of search spaces, and a number of PDCCH MOs;
or
a transmission resource of the common PDCCH repetition transmission is located in the downlink channel receiving window;
or
a number of resources existing within the downlink channel transmission period is associated with some or all parameters in the configuration information, and the number of resources includes at least one of the following: a number of CORESETs, a number of search spaces, and a number of PDCCH MOs;
or
a transmission resource of the common PDCCH repetition transmission is located within the downlink channel transmission period.

The number of CORESETs, the number of search spaces, and the number of PDCCH MOs may be used for indicating the number of repetitions of the common PDCCH. The number of CORESETs, the number of search spaces, and the number of PDCCH MOs are the same as or multiple of the number of repetitions of the common PDCCH. Alternatively, the number of CORESETs, the number of search spaces, and the number of PDCCH MOs may be used for indicating the function of the common PDCCH repetition transmission, for example, a specific number of CORESETs, search spaces, and PDCCH MOs indicates supporting the common PDCCH repetition transmission.

In the foregoing implementation, the configuration information is indicated by using the number of CORESETs, the number of search spaces, and the number of PDCCH MOs, to reduce configuration overheads.

The fact that the transmission resource of the common PDCCH repetition transmission is located in the downlink channel receiving window may indicate that a transmission resource/pattern during actual transmission of the common PDCCH repetition transmission is in the downlink channel receiving window, such as dropping PDCCH transmission that is not located in the downlink channel receiving window.

The fact that the transmission resource of the common PDCCH repetition transmission is located within the downlink channel transmission period may indicate that a transmission resource/pattern during actual transmission of the common PDCCH repetition transmission is within the downlink channel transmission period, such as dropping PDCCH transmission that is not located within the downlink channel transmission period.

In the foregoing implementation, an actual transmission resource of PDCCH repetition transmission may be accurately determined through the downlink channel receiving window or the downlink channel transmission period, to further improve reliability of common PDCCH reception.

Optionally, the downlink channel receiving window includes at least one of the following:
a window configured for the common PDCCH repetition transmission, a receiving window of a downlink channel defined in a protocol, and a window determined based on a downlink channel transmission parameter;
or
a downlink channel receiving period includes at least one of the following:
a period configured for the common PDCCH repetition transmission, a receiving period of a downlink channel defined in a protocol, and a period determined based on a downlink channel transmission parameter.

The window configured by the network side for the common PDCCH repetition transmission can be understood as a new window configured by the network, for example, the network side configures a window starting moment, an offset, a window size, a window end moment, or a window period.

The period configured by the network side for the common PDCCH repetition transmission can be understood as a new period configured by the network, for example, the network side configures a period starting moment, an offset, period duration, or a period end moment.

The window determined based on the downlink channel transmission parameter may be a window determined based on an existing downlink channel transmission parameter. For example, the window is determined based on an SSB period and a relationship between the SSB and CORESET0, and if a starting moment of the downlink channel receiving window is a location of a 1^{st} CORESET #0 after SSB transmission, a size of the window is the period of the SSB; or the starting moment of the downlink channel receiving window is a location of a 1^{st} CORESET #0 after SSB transmission, and an end moment of the window is a location of a last CORESET #0 before next SSB transmission.

The period determined based on the downlink channel transmission parameter may be a period determined based on an existing downlink channel transmission parameter, for example, the period is determined based on an SSB period and a relationship between the SSB and CORESET0.

The receiving window of the downlink channel defined in the protocol may include a window corresponding to at least one of the following:
a random access response window (RAR window);
a contention resolution timer (contention resolution timer); and
a message B-response window (MsgB response window).

The receiving period of the downlink channel defined in the protocol may include: an association period between an SSB and a random access channel occasion (RO);
an SSB period;
an SIB1 period; and
a period of a search space.

In the foregoing implementation, the downlink channel receiving window or the downlink channel receiving period may be determined in a plurality of manners, to support more flexible repetition transmission of the common PDCCH.

In an optional implementation, the common PDCCH repetition transmission satisfies at least one of the following:
a time domain resource of the common PDCCH repetition transmission in CORESET #0 does not overlap with a time domain resource of an associated SSB; or a time domain resource of the common PDCCH repetition transmission in CORESET #0 overlaps with a time domain resource of an associated SSB;
the common PDCCH repetition transmission has a same number of transmissions within a plurality of SSB periods;
the common PDCCH repetition transmission has a same number of transmissions within a plurality of first periods, and the first period is a period within which an SSB is associated with an RO;
the common PDCCH repetition transmission is located in the downlink channel receiving window; and
the common PDCCH repetition transmission is located within the downlink channel transmission period.

That a time domain resource of the common PDCCH repetition transmission in CORESET #0 does not overlap with a time domain resource of an associated SSB may be due to the fact that when the SSB and CORESET #0 are in the multiplexing mode 1 or 2, the SSB cannot overlap, in time domain, with a CORESET #0 resource in which the common PDCCH repetition transmission is performed, that is, the time domain resource of the common PDCCH repetition transmission should avoid a symbol location of a corresponding SSB.

That a time domain resource of the common PDCCH repetition transmission in CORESET #0 overlaps with a time domain resource of an associated SSB may be due to the fact that when the SSB and CORESET #0 are in the multiplexing mode 3, the SSB and the CORESET #0 resource in which the common PDCCH repetition transmission is performed should be at a same moment in time domain.

The common PDCCH repetition transmission has a same number of transmissions within a plurality of SSB periods, which may be that the common PDCCH has a same number of transmissions within each of the plurality of SSB periods, for example, once or more within each SSB period, to facilitate the terminal to monitor the common PDCCH within the plurality of SSB periods.

The common PDCCH repetition transmission has a same number of transmissions within a plurality of first periods, which may be that the common PDCCH has a same number of transmissions within each of the plurality of first periods, for example, once or more within each first period, to facilitate the terminal to monitor the common PDCCH within the plurality of first periods.

In this way, the time domain resource of the common PDCCH repetition transmission may be flexibly determined based on the fact that the SSB and CORESET #0 are in the multiplexing mode, thereby improving reception reliability of the common PDCCH.

In addition, in the foregoing implementation, because the number of repetitions of the common PDCCH repetition transmission is an integer multiple of one SSB period of the SSB, the number of repetitions of the PDCCH repetition transmission may be determined through the SSB period, to reduce configuration overheads. However, the number of repetitions of the common PDCCH repetition transmission is an integer multiple of the period within which the SSB is associated with the RO, so that the number of repetitions of the PDCCH repetition transmission may be determined through the period within which the SSB is associated with the RO, thereby reducing configuration overheads.

In addition, in the foregoing implementation, because the common PDCCH repetition transmission is located in the downlink channel receiving window, or the common PDCCH repetition transmission is within the downlink channel transmission period, the transmission resource of the common PDCCH repetition transmission may be determined through the downlink channel receiving window or the downlink channel receiving period, thereby reducing configuration overheads.

In an optional implementation, the common PDCCH repetition transmission includes at least one of the following:
repetition transmission of the common PDCCH in time domain;
repetition transmission of the common PDCCH in frequency domain; and
repetition transmission of the common PDCCH in spatial domain.

In some implementations, the repetition transmission of the common PDCCH in time domain includes at least one of the following:
repetition transmission of the common PDCCH on different PDCCH MOs in a same search space of a same CORESET;
repetition transmission of the common PDCCH in different search spaces of a same CORESET;
repetition transmission of the common PDCCH in different search spaces of different CORESETs; and
repetition transmission of the common PDCCH in a same search space of different CORESETs.

The repetition transmission of the common PDCCH on different PDCCH MOs in a same search space of a same CORESET may be repetition transmission of the common PDCCH on different PDCCH MOs in one and the same search space of one and the same CORESET.

The repetition transmission of the common PDCCH in different search spaces of a same CORESET may be repetition transmission of the common PDCCH in different search spaces of one and the same CORESET.

The repetition transmission of the common PDCCH in a same search space of different CORESETs may be that search spaces used for the common PDCCH repetition transmission are the same in different CORESETs.

In some implementations, the repetition transmission of the common PDCCH in frequency domain includes at least one of the following:
repetition transmission of the common PDCCH on a same PDCCH MO of a same CORESET; and
repetition transmission of the common PDCCH on a same PDCCH MO of different CORESETs.

The same PDCCH MO may be located in a same search space or different search spaces.

The repetition transmission of the common PDCCH on a same PDCCH MO of different CORESETs can be understood as that different transmissions (or referred to as different repetitions) of the common PDCCH are duplicated for a plurality of copies on CORESET resources at one moment.

In the foregoing implementation, repetition transmission in time domain, frequency domain, or spatial domain may be realized, and transmission performance of the common PDCCH is further improved.

In an optional implementation, the method further includes:
dropping, by the terminal, reception of repetition transmission of the common PDCCH in a case that a resource for repetition transmission of the common PDCCH conflicts with a resource for a first transmission of another common PDCCH.

The dropping, by the terminal, reception of repetition transmission of the common PDCCH may be that the terminal drops monitoring or detection of repetition transmission of the common PDCCH.

That a resource for repetition transmission of the common PDCCH conflicts with a resource for a first transmission of another common PDCCH may be that the resource for repetition transmission of the common PDCCH overlaps with the resource for the first transmission of another common PDCCH. The resource for repetition transmission of the common PDCCH may be a resource for a transmission of the common PDCCH. For example, if a resource for an n^{th} transmission of the common PDCCH conflicts with the resource for the first transmission of another common PDCCH, the n^{th} transmission is dropped.

In addition, when the terminal drops repetition transmission of the common PDCCH, the dropped transmission is counted in a total number of repetition transmissions of the common PDCCH, or the dropped transmission is not counted in a total number of repetition transmissions of the common PDCCH, that is, in a case of dropping the repetition transmission, the number of repetitions of the common PDCCH +1 or not +1, which is specifically specified in a protocol or configured by the network side, or determined based on a service or a transmission resource.

In this implementation, because the terminal drops the repetition transmission of the common PDCCH in a case that the resource for the repetition transmission of the common PDCCH conflicts with the resource for the first transmission of another common PDCCH, the first transmission of the common PDCCH may be guaranteed first, to improve transmission performance of the common PDCCH.

In an optional implementation, in a case that the common PDCCH includes a plurality of types of PDCCHs, repetition information of the plurality of types of PDCCHs is determined independently; or repetition information of some or all of the plurality of types of PDCCHs is determined uniformly. The repetition information may be configuration information of the common PDCCH repetition transmission or timeline information of the common PDCCH repetition transmission.

The repetition information of the plurality of types of PDCCHs is determined independently, which may be that for each common PDCCH repetition transmission, there may be an indication for corresponding repetition information, so that repetition information of each common PDCCH repetition transmission is independently indicated, and flexibility of common PDCCH transmission may be improved to meet requirements of more terminals, services, or scenarios.

For example, there are indications for repetition information of SIB1 PDCCH repetition transmission, repetition information of OSI PDCCH repetition transmission, repetition information of Msg2/4/B PDCCH repetition transmission, repetition information of Paging PDCCH repetition transmission, and repetition information of PDCCH repetition transmission for scheduling Msg3 retransmission.

The repetition information of some or all of the plurality of types of PDCCHs is determined uniformly, which can be that some or all of the plurality of types of PDCCHs correspond to only one indication for the repetition information, so that repetition information of different Common PDCCH repetition transmissions is uniformly indicated, thereby reducing transmission overheads.

For example, repetition information of repetition transmission of a plurality of types of common PDCCHs (such as SIB1 PDCCH, OSI PDCCH, Msg2/4/B PDCCH, Paging PDCCH, and the PDCCH for scheduling Msg3 retransmission) is indicated by indicating repetition information of common PDCCH repetition transmission only once.

In an optional implementation, that the terminal performs PDCCH repetition transmission based on the configuration information of the PDCCH repetition transmission includes:

performing, by the terminal, the PDCCH repetition transmission based on the configuration information of the PDCCH repetition transmission and timeline information of the common PDCCH repetition transmission, the timeline information of the common PDCCH repetition transmission including at least one of the following:
a time sequence relationship between the common PDCCH repetition transmission and a PDSCH scheduled by the common PDCCH;
a time relationship between the common PDCCH repetition transmission and an RAR receiving window;
a time relationship between the common PDCCH repetition transmission and a contention resolution timer; and
a time relationship between the common PDCCH repetition transmission and a MsgB response window.

The time sequence relationship between the common PDCCH repetition transmission and a PDSCH scheduled by the common PDCCH may be a time domain interval relationship or offset relationship between the common PDCCH repetition transmission and the PDSCH scheduled by the common PDCCH.

Optionally, the time sequence relationship between the common PDCCH repetition transmission and the PDSCH scheduled by the common PDCCH includes one of the following:
a slot offset of the PDSCH scheduled by the common PDCCH is an offset relative to a slot in which a first transmission of the common PDCCH repetition transmission is located;
a slot offset of the PDSCH scheduled by the common PDCCH is a slot offset relative to a slot in which a last transmission of the common PDCCH repetition transmission is located;
a slot offset of the PDSCH scheduled by the common PDCCH is a slot offset relative to a slot in which an n^{th} transmission of the common PDCCH repetition transmission is located, and a value of n is configured by a network side or specified in a protocol; and
a slot offset of the PDSCH scheduled by the common PDCCH is an offset relative to a target time point of a receiving window associated with the common PDCCH repetition transmission.

The value of n may be specified in a protocol, configured by a network, or determined in advance.

In a case that the slot offset is 0 (such as slot offset K0=0), it indicates that a transmission of a PDSCH and a transmission of a PDCCH scheduling the PDSCH are in a same slot. In this case, the relationship between the starting symbol of the PDSCH and the Common PDCCH includes one or more of the following:
the starting symbol of the PDSCH and the starting symbol of the Common PDCCH are separated by N symbols, where N>=0; and
the starting symbol of the PDSCH and a last symbol of the Common PDCCH are separated by N symbols, where N>=0.

The receiving window associated with the common PDCCH repetition transmission may be a time window for receiving the common PDCCH, such as an RAR receiving window or an MsgB response window.

The target time point may be specified in a protocol or configured by the network side, for example, the target time point may be a 1^{st} slot in which the receiving window is located.

In some implementations, the first transmission of the common PDCCH includes one of the following:
a first transmission of the common PDCCH repetition transmission in a physical slot;
a first transmission of the common PDCCH repetition transmission in an available slot;
a first transmission of the common PDCCH repetition transmission in the RAR receiving window;
a first transmission of the common PDCCH repetition transmission in the MsgB response window; and
a first valid transmission of the common PDCCH repetition transmission.

In some implementations, the last transmission of the common PDCCH repetition transmission includes one of the following:
a last transmission of the common PDCCH repetition transmission in a physical slot;
a last transmission of the common PDCCH repetition transmission in an available slot;
a last transmission of the common PDCCH repetition transmission in the RAR
a last transmission of the common PDCCH repetition transmission in the MsgB response window; and
a last valid transmission of the common PDCCH repetition transmission.

In some implementations, the n^{th} transmission of the common PDCCH repetition transmission includes one of the following:
an n^{th} transmission of the common PDCCH repetition transmission in a physical slot;
an n^{th} transmission of the common PDCCH repetition transmission in an available slot;
an n^{th} transmission of the common PDCCH repetition transmission in the RAR receiving window;
an n^{th} transmission of the common PDCCH repetition transmission in the MsgB response window; and
an n^{th} valid transmission of the common PDCCH repetition transmission.

In the foregoing implementation, a plurality of time sequence relationships between the common PDCCH repetition transmission and the PDSCH scheduled by the common PDCCH may be supported, so that more flexible reception of the common PDCCH and the PDSCH may be supported, thereby improving downlink transmission performance of the terminal.

Optionally, the time relationship between the common PDCCH repetition transmission and the RAR receiving window includes one of the following:
the common PDCCH repetition transmission is allowed to cross the RAR receiving window, and the common PDCCH repetition transmission is not allowed to cross the RAR receiving window;
or
the time relationship between the common PDCCH repetition transmission and a contention resolution timer includes one of the following:

the common PDCCH repetition transmission is allowed to cross the contention resolution timer, and the common PDCCH repetition transmission is not allowed to cross the contention resolution timer;
or
the time relationship between the common PDCCH repetition transmission and a MsgB response window includes one of the following:
the common PDCCH repetition transmission is allowed to cross the MsgB response window, and the common PDCCH repetition transmission is not allowed to cross the MsgB response window.

The common PDCCH repetition transmission is allowed to cross the RAR receiving window provided that the first transmission of the common PDCCH is in the RAR receiving window, and other transmissions may not be in the RAR receiving window, thereby further improving receiving reliability of the common PDCCH.

That the common PDCCH repetition transmission is not allowed to cross the RAR receiving window may include at least one of the following:
for transmission resources of the common PDCCH that are not in the RAR receiving window, determining that these transmission resources are not used for the common PDCCH repetition transmission, where if no resource is found in the RAR receiving window for performing PDCCH repetition transmission for N times or more, the PDCCH repetition transmission is not performed, where N is a number of PDCCH repetition transmissions configured by the network;
the terminal does not expect the common PDCCH to exceed the RAR receiving window; and
the terminal monitors only the common PDCCH in the RAR receiving window, and drops transmission of the common PDCCH exceeding the RAR receiving window.

In the foregoing implementation, because the common PDCCH repetition transmission is allowed to cross the RAR receiving window, the terminal only needs to monitor the common PDCCH in the RAR receiving window, thereby reducing power consumption of the terminal.

For the description of whether it is allowed to cross the contention resolution timer or the MsgB response window, refer to the corresponding description of the RAR receiving window. Details are not described herein again, and a same beneficial effect can be achieved.

Optionally, the RAR receiving window includes: an RAR receiving window available for the common PDCCH repetition transmission; or an RAR receiving window that is obtained after an offset is added to an RAR receiving window not available for the common PDCCH repetition transmission;
or
the message B-response window includes:
a message B-response window available for the common PDCCH repetition transmission; or a message B-response window that is obtained after an offset is added to a message B-response window not available for the common PDCCH repetition transmission;
or
the contention resolution timer includes:
a defined contention resolution timer available for the common PDCCH repetition transmission; or a contention resolution timer that is obtained after an offset is added to a contention resolution timer not available for the common PDCCH repetition transmission.

The offset may be configured by a network or determined in advance.

The RAR receiving window available for the common PDCCH repetition transmission may be a newly defined RAR receiving window for the common PDCCH repetition transmission, for example, referred to as an RAR repetition receiving window (RAR-repetition window). The RAR repetition receiving window may replace an RAR window, or the RAR repetition receiving window takes effect after the RAR receiving window expires, or duration of the RAR repetition receiving window is related to the repetition information (for example, the number of repetitions) of the common PDCCH repetition transmission. For example, a length of the RAR repetition receiving window is a configured RAR receiving window multiplied by the number of repetitions of the common PDCCH.

The RAR receiving window that is obtained after an offset is added to an RAR receiving window not available for the common PDCCH repetition transmission may be an extension of the RAR receiving window not available for the common PDCCH repetition transmission. The offset may be defined by a network configuration or a protocol agreement or determined by the repetition information of the common PDCCH repetition transmission, and a unit thereof may be symbol, slot, millisecond, or the like.

Total duration of the RAR receiving window that is obtained after an offset is added to an RAR receiving window not available for the common PDCCH repetition transmission or duration of the RAR receiving window available for the common PDCCH repetition transmission cannot exceed duration M. If the duration exceeds the duration M, it is considered as the duration M. Specifically, the duration M may be 10 ms, or other values predefined by the network.

In the foregoing implementation, due to the defined RAR receiving window available for the common PDCCH repetition transmission, the RAR receiving window may better match the common PDCCH, and it is beneficial for the terminal to better monitor the common PDCCH. Due to the RAR receiving window that is obtained after an offset is added to an RAR receiving window not available for the common PDCCH repetition transmission, the existing RAR receiving window may be used, thereby reducing complexity.

The defined MsgB response window available for the common PDCCH repetition transmission may be a newly defined window for the common PDCCH repetition transmission. The window may replace a defined MsgB response window in the protocol, or the window takes effect after the MsgB response window expires, or duration of the window is related to the repetition information (for example, the number of repetitions) of the common PDCCH repetition transmission. For example, a length of the window is a configured RAR receiving window multiplied by the number of repetitions of the common PDCCH.

The MsgB response window that is obtained after an offset is added to a MsgB response window not available for the common PDCCH repetition transmission may be an extension of the MsgB response window not available for the common PDCCH repetition transmission. The offset may be defined by a network configuration or a protocol agreement or determined by the repetition information of the common PDCCH repetition transmission, and a unit thereof may be symbol, slot, millisecond, or the like.

Total duration of the MsgB response window that is obtained after an offset is added to a MsgB response window not available for the common PDCCH repetition transmission or duration of the MsgB response window available for the common PDCCH repetition transmission cannot exceed duration M. If the duration exceeds the duration M, it is considered as the duration M. Specifically, the duration M may be 10 ms, or other values predefined by the network.

In the foregoing implementation, due to the MsgB response window available for the common PDCCH repetition transmission, the MsgB response window may better match the common PDCCH, and it is beneficial for the terminal to better monitor the common PDCCH. Due to the MsgB response window that is obtained after an offset is added to an MsgB response window not available for the common PDCCH repetition transmission, the existing MsgB response window may be used, thereby reducing complexity.

The defined contention resolution timer available for the common PDCCH repetition transmission may be a newly defined contention resolution timer for the common PDCCH repetition transmission. The timer may replace a defined contention resolution timer in the protocol, or the timer takes effect after the contention resolution timer expires, or a length of the timer is related to the repetition information (for example, the number of repetitions) of the common PDCCH repetition transmission. For example, a length of the timer is a configured RAR receiving window multiplied by the number of repetitions of the common PDCCH.

The contention resolution timer that is obtained after an offset is added to a contention resolution timer not available for the common PDCCH repetition transmission may be an extension of the contention resolution timer not available for the common PDCCH repetition transmission. The offset may be defined by a network configuration or a protocol agreement or determined by the repetition information of the common PDCCH repetition transmission, and a unit thereof may be symbol, slot, millisecond, or the like.

Total duration of the contention resolution timer that is obtained after an offset is added to a contention resolution timer not available for the common PDCCH repetition transmission or duration of the contention resolution timer available for the common PDCCH repetition transmission cannot exceed duration M. If the duration exceeds the duration M, it is considered as the duration M. Specifically, the duration M may be 10 ms, or other values predefined by the network.

In the foregoing implementation, due to the defined contention resolution timer available for the common PDCCH repetition transmission, the contention resolution timer may better match the common PDCCH, and it is beneficial for the terminal to better monitor the common PDCCH. Due to the contention resolution timer that is obtained after an offset is added to a contention resolution timer not available for the common PDCCH repetition transmission, the existing contention resolution timer may be used, thereby reducing complexity.

Optionally, a starting moment of the RAR receiving window includes:
a 1^{st} symbol of a CORESET that meets a target condition earliest in a first resource, where
the first resource includes:
a resource that is located after a last symbol occupied by a PRACH and that is separated from the last symbol occupied by the PRACH by at least one symbol; or
a resource that is located after a last symbol occupied by a PRACH and that is separated from the last symbol occupied by the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a MAC CE.

The target condition may be a condition defined in a protocol or configured by the network side. For example, the CORESET meeting the target condition may be a CORESET in which a transmission of the common PDCCH is located.

In some implementations, the CORESET meeting the target condition includes:
a CORESET in which an i^{th} transmission of the common PDCCH repetition transmission is located, a value of i being equal to or greater than 1 and less than or equal to the number of repetitions of the common PDCCH.
i may be defined in a protocol or configured by the network side, for example, the i^{th} transmission is the first transmission of the common PDCCH.

The PRACH may be a PRACH corresponding to the common PDCCH.

In the foregoing implementation, the 1^{st} symbol of the CORESET that meets the target condition earliest in the first resource may be used as the RAR receiving window, so that the terminal can better monitor the common PDCCH in the RAR receiving window. In addition, because the first resource includes the resource that is located after the last symbol occupied by the PRACH and that is separated from the last symbol occupied by the PRACH by at least one symbol, the PRACH may be separated from the common PDCCH by at least one symbol, so that the terminal can better monitor the common PDCCH. The first resource is located after a last symbol of a physical uplink shared channel (PUSCH) occasion corresponding to the PRACH and is separated from the last symbol of the physical uplink shared channel (PUSCH) occasion corresponding to the PRACH by an interval greater than or equal to the target time, so that the PRACH may be separated from the common PDCCH by at least one symbol +T_{TA}+k_{mac}. In this way, the terminal can better monitor the common PDCCH.

Optionally, a starting moment of the contention resolution timer includes a first moment after an end of transmission of Msg3, or an interval between a starting moment of the contention resolution timer and a transmission end moment of Msg3 is equal to or greater than a round trip time (RTT), where
the first moment includes at least one of the following:
a 1^{st} symbol of a next slot after the end of transmission of Msg3;
a 1^{st} symbol of an earliest CORESET after the end of transmission of Msg3; and
a 1^{st} symbol of a CORESET that meets a target condition earliest in a second resource, where
the second resource includes:
a resource that is separated from the end of transmission of Msg3 by at least one symbol after the end of transmission of Msg3.

In a case of repetition transmission of the message 3, the end of transmission of Msg3 indicates an end of all transmissions of the repetition transmission of Msg3.

For the CORESET of the target condition, refer to the corresponding description of the foregoing implementation. Details are not described herein again.

In some implementations, in an NTN scenario, the interval between the starting moment of the contention resolution timer and the transmission end moment of Msg3 is equal to or greater than the RTT.

In the foregoing implementation, the starting moment of the contention resolution timer includes the first moment after the end of transmission of Msg3, so that the terminal may monitor the common PDCCH in the contention resolution timer after transmitting Msg3. In this way, the terminal can better monitor the common PDCCH. However, the interval between the starting moment of the contention resolution timer and the transmission end moment of Msg3 is equal to or greater than the RTT, so that Msg3 may be separated from the common PDCCH by the RTT. In this way, the terminal can better monitor the common PDCCH.

Optionally, the starting moment of the MsgB response window includes at least one of the following:
a 1^{st} symbol of a CORESET in which the first transmission of the common PDCCH repetition transmission is located;
a 1^{st} symbol of a CORESET in which the last transmission of the common PDCCH repetition transmission is located;
a 1^{st} symbol of a CORESET in which an i^{th} transmission of the common PDCCH repetition transmission is located, a value of i being equal to or greater than 1 and less than or equal to a number of repetitions of the common PDCCH;
a 1^{st} symbol of an earliest CORESET in a third resource; and
a 1^{st} symbol of a CORESET that meets a target condition earliest in a third resource, where
the third resource includes:
a resource that is located after a last symbol of a physical uplink shared channel (PUSCH) occasion corresponding to a PRACH and that is separated from the last symbol of the PUSCH occasion corresponding to the PRACH by at least one symbol; or
a resource that is located after a last symbol of a PUSCH occasion corresponding to a PRACH and that is separated from the last symbol of the PUSCH occasion corresponding to the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

For the CORESET of the target condition and T_{TA}+k_{mac}, refer to the corresponding description of the foregoing implementation. Details are not described herein again.

The PRACH may be a PRACH corresponding to the common PDCCH.

In the foregoing implementation, the starting moment of the MsgB response window may be flexibly configured to meet requirements of more terminals, services, or scenarios.

In an optional implementation, the method further includes:
deactivating the common PDCCH repetition transmission when any one of the following is met:
the terminal sends the message 3;
the terminal receives a success RAR;
the RAR receiving window ends;
a maximum allowed RAR window ends;
the contention resolution timer expires;
a message 4 is decoded successfully;
the message B is decoded successfully; and
a network side configuration performs deactivation.

For example, deactivating the common PDCCH repetition transmission after the terminal sends Msg3;
deactivating the common PDCCH repetition transmission after the terminal receives a success RAR;
deactivating the common PDCCH repetition transmission after the RAR receiving window;
deactivating the common PDCCH repetition transmission after the maximum allowed RAR window;
deactivating the common PDCCH repetition transmission after the contention resolution timer expires;
deactivating the common PDCCH repetition transmission after Msg4 is decoded successfully;
deactivating the common PDCCH repetition transmission after MsgB is decoded successfully; and
deactivating the common PDCCH repetition transmission by the network side configuration.

The deactivating after the terminal sends Msg3, deactivating after the terminal receives a success RAR, deactivating after the RAR receiving window, deactivating after the maximum allowed RAR window, deactivating after the contention resolution timer expires, deactivating after Msg4 is decoded successfully, and deactivating after MsgB is decoded successfully may be deactivating the common PDCCH repetition transmission immediately or at an interval of at least one time domain resource after the terminal sends Msg3, after the terminal receives a success RAR, after the RAR receiving window, after the maximum allowed RAR window, after the contention resolution timer expires, after Msg4 is decoded successfully, and after MsgB is decoded successfully. The time domain resource may be a symbol or a slot.

The network side configuration includes at least one of the following:
configuring by using an RRC message;
configuring by using a MAC CE message;
configuring by using an RAR, for example, an RAR in 4-step RACH, a fallback RA in 2-step RACH, or a success RAR, for example, the RAR indicates whether to support repetition of a subsequent Msg4 PDCCH; and
configuring by using DCI, for example, indicating, by using a PDCCH for scheduling SIB1, whether the following RAR PDCCH, Msg4 PDCCH, and paging PDCCH support repetition transmission.

In this implementation, the common PDCCH repetition transmission may be deactivated flexibly in the above cases, thereby improving transmission flexibility of the common PDCCH.

In an optional implementation, in a case that the i^{th} transmission of the common PDCCH repetition transmission and the PDSCH scheduled by the common PDCCH are in a same slot, a relationship between a starting symbol of the PDSCH scheduled by the common PDCCH and the common PDCCH repetition transmission includes at least one of the following:
the starting symbol of the PDSCH scheduled by the common PDCCH is separated from a starting symbol of the i^{th} transmission of the common PDCCH repetition transmission by N symbols; and
the starting symbol of the PDSCH scheduled by the common PDCCH is separated from a symbol of the i^{th} transmission of the common PDCCH repetition transmission by N symbols, where
the value of i is equal to or greater than 1, and less than or equal to the number of repetitions of the common PDCCH, and N is greater than or equal to 0.

N is specified in a protocol or configured by the network side.

In this implementation, the transmission resource of the common PDCCH repetition transmission may be determined based on the starting symbol of the PDSCH of the common PDCCH. This may avoid introducing additional signaling and reduce transmission overheads.

In this embodiment of this application, the common PDCCH may be all or some of the common PDCCHs supported by the terminal, and the manner for determining the repetition information may be applicable to all or some of the common PDCCHs supported by the terminal.

In this embodiment of this application, the terminal obtains configuration information of common PDCCH repetition transmission; and the terminal receives the common PDCCH repetition transmission based on the configuration information. The common PDCCH includes at least one of the following: an SIB1 PDCCH, an OSI PDCCH, a message 2 PDCCH, a message 4 PDCCH, a message B PDCCH, a paging PDCCH, and a PDCCH for scheduling message 3 retransmission. In this way, the terminal can receive the common PDCCH repetition transmission, thereby improving coverage performance of the network.

For example, before the RRC connection of the terminal is established, the network side device uses the common PDCCH to send scheduling information of some common messages (such as RMSI/OSI/Paging/Msg2/MsgB/Msg4). In some scenarios, such as the NTN scenario, a PDCCH for scheduling Msg2 is transmitted repeatedly, so that the terminal can receive the PDCCH better, to receive Msg2, thereby improving a success rate of random access.

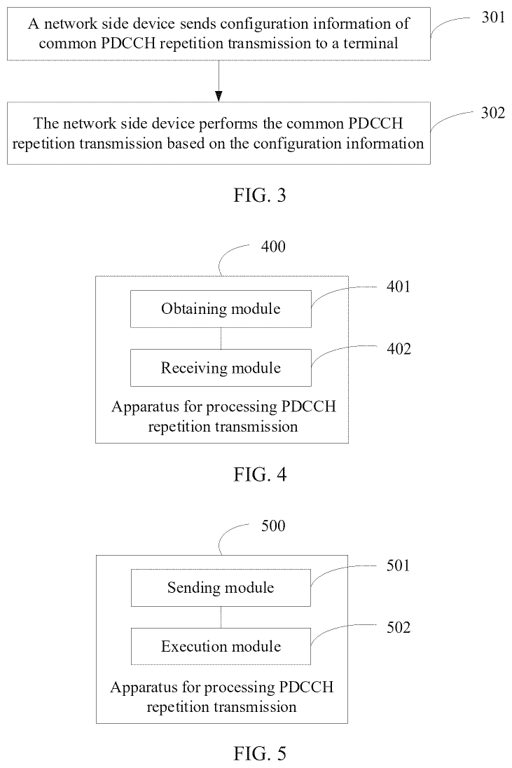

Referring to FIG. 3, FIG. 3 is a flowchart of another method for processing PDCCH repetition transmission according to an embodiment of this application. As shown in FIG. 3, the method includes the following steps.

Step 301: A network side device sends configuration information of common PDCCH repetition transmission to a terminal.

Step 302: The network side device performs the common PDCCH repetition transmission based on the configuration information.

The common PDCCH includes at least one of the following:
a system information block (SIB) 1 PDCCH, an OSI PDCCH, a message 2 PDCCH, a message 4 PDCCH, a message B PDCCH, a paging PDCCH, and a PDCCH for scheduling message 3 retransmission.

Optionally, the configuration information includes at least one of the following parameters:
a function of the common PDCCH repetition transmission;
a number of repetitions of the common PDCCH repetition transmission;
an index of the common PDCCH repetition transmission;
resource information of the common PDCCH repetition transmission;
activation information of the common PDCCH repetition transmission, the activation information representing activation or deactivation of the common PDCCH repetition transmission; and
a repetition mode of the common PDCCH repetition transmission.

Optionally, the resource information of the common PDCCH repetition transmission includes at least one of the following:
a pattern of the common PDCCH repetition transmission, the pattern indicating a resource location occupied by the common PDCCH repetition transmission;
indication information for indicating that the common PDCCH repetition transmission is performed based on an available slot; and
indication information for indicating that the common PDCCH repetition transmission is performed based on a physical slot.

Optionally, the repetition mode of the common PDCCH repetition transmission includes at least one of the following:
intra-slot repetition transmission; and
inter-slot repetition transmission.

Optionally, the sending, by a network side device, configuration information of common PDCCH repetition transmission to a terminal includes:
sending, by the network side device, indication information to the terminal, the indication information being used for determining the configuration information of the common PDCCH repetition transmission, and the indication information including at least one of the following:
a synchronization signal block (SSB), a master information block (MIB), a physical broadcast channel (PBCH), a system information block (SIB), a radio network temporary identifier (RNTI), a control resource set (CORESET) configuration table, a monitoring occasion table of a common search space (CSS), a downlink channel receiving window, a downlink channel transmission period, a CORESET resource, a search space, a physical downlink control channel (PDCCH) monitoring occasion (MO), a physical random access channel (PRACH) resource, an SIB1 PDCCH, a message 2, a message B, a message 2 PDCCH, a message B PDCCH, a PDCCH for scheduling message 3 retransmission, radio resource control (RRC) signaling, a medium access control control element (MAC CE), a random access response, downlink control information (DCI), and a message 3.

Optionally, at least one of the following items in the PBCH is used for indicating some or all of the configuration information:
a demodulation reference signal (DMRS) of the PBCH, a scrambling sequence of the PBCH, and a payload of the PBCH, where
the DMRS includes at least one of the following: a DMRS sequence, a DMRS pattern, a DMRS time domain resource, and a DMRS frequency domain resource.

Optionally, the RNTI includes a first RNTI defined for the common PDCCH repetition transmission, and the first RNTI is used for scrambling downlink control information (DCI) related to the common PDCCH, where
a generation manner of the first RNTI includes at least one of the following:
being generated based on a random access radio network temporary identifier (RA-RNTI) and an offset;
being generated based on a system information radio network temporary identifier (SI-RNTI) and an offset;
being generated based on a temporary cell radio network temporary identifier (TC-RNTI) and an offset;
being generated based on a paging radio network temporary identifier (P-RNTI) and an offset; and
being generated based on a message B radio network temporary identifier (MsgB-RNTI) and an offset, where
the offset is associated with the configuration information of the common PDCCH repetition transmission.

Optionally, the CORESET configuration table includes a first CORESET configuration table, the first CORESET configuration table is a CORESET resource configuration table for a type0-PDCCH search space set, and different resource configurations in the first CORESET configuration table correspond to respective configuration parameters of common PDCCH repetition transmission; or the CORESET configuration table includes a second CORESET configuration table, the second CORESET configuration table is a CORESET resource configuration table defined for the common PDCCH repetition transmission, and different indexes in the second CORESET configuration table correspond to respective configuration parameters of common PDCCH repetition transmission, where the configuration parameters of the common PDCCH repetition transmission are at least some parameters included in the configuration information of the common PDCCH repetition transmission;
or
the monitoring occasion table of the CSS includes a monitoring occasion table of a first CSS, the monitoring occasion table of the first CSS is a PDCCH monitoring occasion table for a type0-PDCCH search space set, and parameters of different PDCCH monitoring occasions in the monitoring occasion table of the first CSS correspond to respective configuration parameters of common PDCCH repetition transmission; or the monitoring occasion table of the CSS includes a monitoring occasion table of a second CSS, the monitoring occasion table of the second CSS is a CSS monitoring occasion table defined for the common PDCCH repetition transmission, and different indexes in the monitoring occasion table of the second CSS correspond to respective configuration parameters of common PDCCH repetition transmission, where the configuration parameters of the common PDCCH repetition transmission are at least some parameters included in the configuration information of the common PDCCH repetition transmission.

Optionally, a number of resources existing in the downlink channel receiving window is associated with some or all parameters in the configuration information, and the number of resources includes at least one of the following: a number of CORESETs, a number of search spaces, and a number of PDCCH MOs;
or
a transmission resource of the common PDCCH repetition transmission is located in the downlink channel receiving window;
or
a number of resources existing within the downlink channel transmission period is associated with some or all parameters in the configuration information, and the number of resources includes at least one of the following: a number of CORESETs, a number of search spaces, and a number of PDCCH MOs;
or
a transmission resource of the common PDCCH repetition transmission is located within the downlink channel transmission period.

Optionally, the downlink channel receiving window includes at least one of the following:
a window configured for the common PDCCH repetition transmission, a receiving window of a downlink channel defined in a protocol, and a window determined based on a downlink channel transmission parameter;
or
a downlink channel receiving period includes at least one of the following:
a period configured for the common PDCCH repetition transmission, a receiving period of a downlink channel defined in a protocol, and a period determined based on a downlink channel transmission parameter.

Optionally, the common PDCCH repetition transmission satisfies at least one of the following:
a time domain resource of the common PDCCH repetition transmission in CORESET #0 does not overlap with a time domain resource of an associated synchronization signal block (SSB); or a time domain resource of the common PDCCH repetition transmission in CORESET #0 overlaps with a time domain resource of an associated SSB;
the common PDCCH repetition transmission has a same number of transmissions within a plurality of SSB periods;
the common PDCCH repetition transmission has a same number of transmissions within a plurality of first periods, and the first period is a period within which an SSB is associated with an RO;
the common PDCCH repetition transmission is located in the downlink channel receiving window; and
the common PDCCH repetition transmission is located within the downlink channel transmission period.

Optionally, the common PDCCH repetition transmission includes repetition transmission in time domain, and repetition transmission of the common PDCCH in time domain includes at least one of the following:
repetition transmission of the common PDCCH on different PDCCH MOs in a same search space of a same CORESET;
repetition transmission of the common PDCCH in different search spaces of a same CORESET;
repetition transmission of the common PDCCH in different search spaces of different CORESETs; and
repetition transmission of the common PDCCH in a same search space of different CORESETs;
or
the common PDCCH repetition transmission includes repetition transmission in frequency domain, and repetition transmission of the common PDCCH in frequency domain includes at least one of the following:
repetition transmission of the common PDCCH on a same PDCCH MO of a same CORESET; and
repetition transmission of the common PDCCH on a same PDCCH MO of different CORESETs.

Optionally, the method further includes:
dropping, by the terminal, reception of repetition transmission of the common PDCCH in a case that a resource for repetition transmission of the common PDCCH conflicts with a resource for a first transmission of another common PDCCH.

Optionally, the performing, by the network side device, the common PDCCH repetition transmission based on the configuration information includes:
performing, by the network side device, the PDCCH repetition transmission based on the configuration information of the PDCCH repetition transmission and timeline information of the common PDCCH repetition transmission, the timeline information of the common PDCCH repetition transmission including at least one of the following:
a time sequence relationship between the common PDCCH repetition transmission and a physical downlink shared channel (PDSCH) scheduled by a common PDCCH;
a time relationship between the common PDCCH repetition transmission and an RAR receiving window;
a time relationship between the common PDCCH repetition transmission and a contention resolution timer; and
a time relationship between the common PDCCH repetition transmission and a message B-response window.

Optionally, the time sequence relationship between the common PDCCH repetition transmission and the PDSCH scheduled by the common PDCCH includes one of the following:
a slot offset of the PDSCH scheduled by the common PDCCH is an offset relative to a slot in which a first transmission of the common PDCCH repetition transmission is located;
a slot offset of the PDSCH scheduled by the common PDCCH is a slot offset relative to a slot in which a last transmission of the common PDCCH repetition transmission is located;
a slot offset of the PDSCH scheduled by the common PDCCH is a slot offset relative to a slot in which an n^{th} transmission of the common PDCCH repetition transmission is located, and a value of n is configured by a network side or specified in a protocol; and
a slot offset of the PDSCH scheduled by the common PDCCH is an offset relative to a target time point of a receiving window associated with the common PDCCH repetition transmission.

Optionally, the first transmission of the common PDCCH includes one of the following:
a first transmission of the common PDCCH repetition transmission in a physical slot;
a first transmission of the common PDCCH repetition transmission in an available slot;
a first transmission of the common PDCCH repetition transmission in the RAR receiving window;
a first transmission of the common PDCCH repetition transmission in the message B-response window; and
a first valid transmission of the common PDCCH repetition transmission;
or
the last transmission of the common PDCCH repetition transmission includes one of the following:
a last transmission of the common PDCCH repetition transmission in a physical slot;
a last transmission of the common PDCCH repetition transmission in an available slot;
a last transmission of the common PDCCH repetition transmission in the RAR receiving window;
a last transmission of the common PDCCH repetition transmission in the message B-response window; and
a last valid transmission of the common PDCCH repetition transmission;
or
the n^{th} transmission of the common PDCCH repetition transmission includes one of the following:
an n^{th} transmission of the common PDCCH repetition transmission in a physical slot;
an n^{th} transmission of the common PDCCH repetition transmission in an available slot;
an n^{th} transmission of the common PDCCH repetition transmission in the RAR receiving window;
an n^{th} transmission of the common PDCCH repetition transmission in the message B-response window; and
an n^{th} valid transmission of the common PDCCH repetition transmission.

Optionally, the time relationship between the common PDCCH repetition transmission and the RAR receiving window includes one of the following:
the common PDCCH repetition transmission is allowed to cross the RAR receiving window, and the common PDCCH repetition transmission is not allowed to cross the RAR
or
the time relationship between the common PDCCH repetition transmission and a contention resolution timer includes one of the following:
the common PDCCH repetition transmission is allowed to cross the contention resolution timer, and the common PDCCH repetition transmission is not allowed to cross the contention resolution timer;
or
the time relationship between the common PDCCH repetition transmission and a message B-response window includes one of the following:
the common PDCCH repetition transmission is allowed to cross the message B-response window, and the common PDCCH repetition transmission is not allowed to cross the message B-response window.

Optionally, the RAR receiving window includes: an RAR receiving window available for the common PDCCH repetition transmission; or an RAR receiving window that is obtained after an offset is added to an RAR receiving window not available for the common PDCCH repetition transmission;
or
the message B-response window includes:
a message B-response window available for the common PDCCH repetition transmission; or a message B-response window that is obtained after an offset is added to a message B-response window not available for the common PDCCH repetition transmission;
or
the contention resolution timer includes:
a defined contention resolution timer available for the common PDCCH repetition transmission; or a contention resolution timer that is obtained after an offset is added to a contention resolution timer not available for the common PDCCH repetition transmission.

Optionally, a starting moment of the RAR receiving window includes:
a 1^{st} symbol of a CORESET that meets a target condition earliest in a first resource, where
the first resource includes:
a resource that is located after a last symbol occupied by a PRACH and that is separated from the last symbol occupied by the PRACH by at least one symbol; or
a resource that is located after a last symbol occupied by a PRACH and that is separated from the last symbol occupied by the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

Optionally, a starting moment of the contention resolution timer includes a first moment after an end of transmission of the message 3, or an interval between a starting moment of the contention resolution timer and a transmission end moment of the message 3 is equal to or greater than a round trip time (RTT), where
the first moment includes at least one of the following:
a 1^{st} symbol of a next slot after the end of transmission of the message 3;
a 1^{st} symbol of an earliest CORESET after the end of transmission of the message 3; and
a 1^{st} symbol of a CORESET that meets a target condition earliest in a second resource, where
the second resource includes:
a resource that is separated from the end of transmission of the message 3 by at least one symbol after the end of transmission of the message 3.

Optionally, a starting moment of the message B-response window includes at least one of the following:
a 1^{st} symbol of a CORESET in which the first transmission of the common PDCCH repetition transmission is located;
a 1^{st} symbol of a CORESET in which the last transmission of the common PDCCH repetition transmission is located;
a 1^{st} symbol of a CORESET in which an i^{th} transmission of the common PDCCH repetition transmission is located, a value of i being equal to or greater than 1 and less than or equal to a number of repetitions of the common PDCCH;
a 1^{st} symbol of an earliest CORESET in a third resource; and
a 1^{st} symbol of a CORESET that meets a target condition earliest in a third resource, where
the third resource includes:
a resource that is located after a last symbol of a physical uplink shared channel (PUSCH) occasion corresponding to a PRACH and that is separated from the last symbol of the PUSCH occasion corresponding to the PRACH by at least one symbol; or
a resource that is located after a last symbol of a PUSCH occasion corresponding to a PRACH and that is separated from the last symbol of the PUSCH occasion corresponding to the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

Optionally, the CORESET that meets a target condition includes:
a CORESET in which an i^{th} transmission of the common PDCCH repetition transmission is located, a value of i being equal to or greater than 1 and less than or equal to the number of repetitions of the common PDCCH.

Optionally, the method further includes:
deactivating the common PDCCH repetition transmission when any one of the following is met:
the terminal sends the message 3;
the terminal receives a success RAR;
the RAR receiving window ends;
a maximum allowed RAR window ends;
the contention resolution timer expires;
a message 4 is decoded successfully;
the message B is decoded successfully; and
a network side configuration performs deactivation.

Optionally, in a case that the i^{th} transmission of the common PDCCH repetition transmission and the PDSCH scheduled by the common PDCCH are in a same slot, a relationship between a starting symbol of the PDSCH scheduled by the common PDCCH and the common PDCCH repetition transmission includes at least one of the following:
the starting symbol of the PDSCH scheduled by the common PDCCH is separated from a starting symbol of the i^{th} transmission of the common PDCCH repetition transmission by N symbols; and
the starting symbol of the PDSCH scheduled by the common PDCCH is separated from a symbol of the i^{th} transmission of the common PDCCH repetition transmission by N symbols, where
the value of i is equal to or greater than 1, and less than or equal to the number of repetitions of the common PDCCH, and N is greater than or equal to 0.

It should be noted that this embodiment is used as an implementation of the network side device corresponding to the embodiment shown in FIG. 2. For a specific implementation of this embodiment, refer to the related descriptions of the embodiment shown in FIG. 2. To avoid repetition, details are not described in this embodiment again.

The method provided in embodiments of this application is described as examples below by using a plurality of embodiments.

### Embodiment 1

In this embodiment, repetition information of common PDCCH repetition transmission (Common PDCCH repetition) includes one or more of the following:
a function of Common PDCCH repetition (a function indicating whether to support or request repetition);
a number of Common PDCCH repetitions;
an index of Common PDCCH repetition;
a pattern of Common PDCCH repetition; for example, inter-CORESET PDCCH repetition is supported, and CCE locations or PDCCH candidate locations occupied by different PDCCH repetitions in different CORESETs are the same or change in a mode; and for another example, intra-CORESET PDCCH repetition is supported, and CCE locations or PDCCH candidate locations occupied by different PDCCH repetitions in a same CORESET are the same or change in a mode;
whether Common PDCCH repetition is based on an available slot or based on a physical slot;
activation or deactivation of Common PDCCH repetition;
whether Common PDCCH repetition may exceed an RAR window;
whether Common PDCCH repetition may exceed a contention resolution timer; and
whether Common PDCCH repetition may exceed a MsgB response window.

In some embodiments, the repetition information of Common PDCCH repetition is indicated in one or more of the following manners:
being indicated implicitly or explicitly by using an SSB;
being indicated implicitly or explicitly by using an MIB;
being indicated implicitly or explicitly by using a PBCH;
being indicated by using SIB information, the SIB information including SIB1 or another OSI;
being indicated by defining a new Repetition-RNTI;
being indicated by using a modified or newly created CORESET #0 configuration table;
being indicated by using a modified or newly created Type0-PDCCH CSS monitoring occasion table;
being determined by using a window/period;
being indicated by configuring a specific CORESET resource, for example, a PDCCH transmitted by using a specific CORESET resource needs repetition;
being indicated by configuring specific SearchSpace, for example, a PDCCH transmitted by using a specific SearchSpace resource needs repetition;
being indicated by configuring a specific PDCCH MO;
being indicated by using a specific PRACH resource, for example, when the network is configured with a PRACH resource for the terminal to request common PDCCH repetition or for the terminal to report a capability of receiving PDCCH repetition, it indicates that the network supports a common PDCCH repetition function;
being indicated by using an SIB1 PDCCH;
being indicated by using Msg2/MsgB (Msg2/MsgB PDSCH);
being indicated by using Msg2/MsgB PDCCH; and
being indicated by using a PDCCH for scheduling Msg3 retransmission.

In some embodiments, that the repetition information of Common PDCCH repetition is indicated implicitly or explicitly in the MIB includes one or more of the following:
the repetition information is implicitly indicated by using some bits in an existing field in the MIB. For example, the repetition information is implicitly indicated by using a specific value (a subcarrier offset value between an SSB and a common resource block grid) of k_{SSB} in the MIB, such as defining values or groups of k_{SSB} corresponding to different numbers of repetitions. For example, when the value of k_{SSB} is 0 to 1, it indicates that the common PDCCH repetition transmission is not supported; when the value of k_{SSB} is 2 to 3, it indicates that the common PDCCH repetition transmission is supported, and the number of repetitions of the common PDCCH repetition transmission is 2; and when the value of k_{SSB} is 4 to 5, it indicates that the common PDCCH repetition transmission is supported, and the number of repetitions of the common PDCCH repetition transmission is 4; or
the configuration information is explicitly carried in MIB information; and explicitly carried in MIB information, such as using spare bits in the MIB.

In some embodiments, that the repetition information of Common PDCCH repetition is indicated implicitly or explicitly in the PBCH includes one or more of the following:
being indicated by using a DMRS sequence of the PBCH, where generation of the DMRS sequence is related to the repetition information of Common PDCCH repetition, for example, parameters used in initialization of the DMRS sequence include the number of Common PDCCH repetitions;
being indicated by using a scrambling sequence of the PBCH, where generation of the scrambling sequence is related to the repetition information of Common PDCCH repetition, for example, parameters used in initialization of the scrambling sequence include the number of repetitions of Common PDCCH repetition; and
being explicitly carried in the PBCH payload, for example, the number of repetitions of Common PDCCH repetition is explicitly indicated in layer 1 (L1) payload of the PBCH.

In some embodiments, that the repetition information of Common PDCCH repetition is indicated in the SIB includes one or more of the following:
carrying one or more bits of signaling in the SIB to indicate related information of Common PDCCH Repetition; and
adding an indication of the repetition information of Common PDCCH repetition to signaling of a PDCCH common configuration (PD (CH-configCommon).

In some embodiments, the repetition information of Common PDCCH repetition is indicated by defining a new repetition RNTI (Repetition-RNTI), Repetition-RNTI is used to scramble related DCI, and generation of Repetition-RNTI includes one or more of the following: based on RA-RNTI+offset;
based on SI-RNTI+offset;
based on TC-RNTI+offset;
based on P-RNTI+offset; and
based on MSGB-RNTI+offset.

The offset is related to the repetition information of Common PDCCH repetition. For example, different values/value ranges of the offset correspond to different functions/number of repetitions of Common PDCCH repetition.

In some embodiments, that the repetition information of Common PDCCH repetition is indicated by using a modified or newly created CORESET #0 configuration table or Type0-PDCCH CSS monitoring occasion table includes one or more of the following:
adding a new column to a CORESET #0 configuration table or Type0-PDCCH CSS monitoring occasion table in the related technology indicated by PDCCH configuration (PDCCH-config) SIB1;
adding a column to the first CORESET configuration table indicated by a 4 bit MSB in PDCCH-configSIB1, to indicate whether the common PDCCH performs repetition transmission, a number of repetitions, a repetition index, a pattern of repetition transmission, or the like. Details are shown in Table 1 of the foregoing embodiment; or
adding several columns to a related table indicated by a 4 bit LSB (search space #0 (SearchSpaceZero)) in PDCCH-configSIB1, to indicate whether to perform repetition transmission, a number of repetitions, a repetition index, a pattern of repetition transmission, or the like. Details are shown in Table 2 of the foregoing embodiment.

It is indicated by defining a new CORESET #0 configuration table or Type0-PDCCH CSS monitoring occasion table, where the new table is used for determining a specific time domain resource/frequency domain resource/CORESET/SearchSpace/PDCCH MO supporting PDCCH repetition. In addition, the new table may be indicated or determined based on a condition defined in the protocol (such as all or some conditions corresponding to Table 1) and with reference to a new condition. The new condition may be a specific value of k_{SSB}, a specific system frame number, or a spare bit in the MIB. For example, for the CORESET #0 configuration table, the condition defined in the protocol may be a {SSB, PDCCH} subcarrier spacing combination and minimum bandwidth; and for the Type0-PDCCH CSS monitoring occasion table, the condition in the related technology is a multiplexing pattern and frequency range of SSB and CORESET #0.

In some embodiments, the repetition information of Common PDCCH repetition is determined at least based on a window/period, where the determining the repetition information of Common PDCCH repetition based on a window/period includes at least one of the following:
a number of CORESETs, searchSpaces, or PDCCH MO in the window/period indicates a number of PDCCH repetitions; and
the window/period is used for determining a transmission resource/pattern of actual PDCCH repetition. For example, drop PDCCH repetition that is not in the window/Period.

The window/period may be at least one of the following:
a new window configured by the network (including a window starting moment/offset and/or a window size and/or a window end moment, or a window period);
multiplexing a window/period defined in another protocol, for example, an RAR window, a contention resolution timer, a MsgB response window, an SSB to RO association period, an SSB period, an SIB1 period, or a period of SearchSpace; and
a window determined based on a parameter defined in a protocol, for example, being determined based on an SSB period and a relationship between the SSB and CORESET0, or a starting moment of the window is a location of a 1^{st} CORESET #0 after SSB transmission, and a size of the window is the period of the SSB; or the starting moment of the window is a location of a 1^{st} CORESET #0 after SSB transmission, and an end moment of the window is a location of a last CORESET #0 before next SSB transmission.

In some embodiments, the repetition manner indicated in the foregoing embodiment includes intra-slot repetition or inter-slot repetition.

For the intra-slot repetition, all transmissions of the common PDCCH are completed in one slot. With reference to a manner of adding a column in Table 1 in the foregoing embodiment, a 1^{st} symbol index (First symbol index) indicates a starting symbol, and a number of symbols (Number of Symbols) indicates a number of symbols occupied in each transmission. In addition, a single transmission cannot be performed across slot.

For example, when First symbol index=0, and Number of Symbols=3, PDCCH repetition index 0 is on symbol 0/1/2, PDCCH repetition index 1 is on symbol 3/4/5, PDCCH repetition index 2 is on symbol 6/7/8, PDCCH repetition index 3 is on symbol Sep. 10, 2011, and because a number of remaining two symbols is less than Number of Symbols: 3, there is no PDCCH repetition index 4.

For another example, for inter-slot repetition, each transmission is completed in one slot. With reference to a manner of adding a column in Table 1 in the foregoing embodiment, each slot uses same First symbol and Number of symbols as indicated in the table. A repetition number determines a number of consecutive slots for common PDCCH repetition transmission.

In some embodiments, a resource determined by using the Common PDCCH repetition mechanism satisfies multiplexing modes of SSB and CORESET #0.

For multiplexing mode 1 or 2 of SSB and CORESET #0, CORESET #0 resources in which the SSB and the PDCCH repetition are located cannot overlap in time domain, that is, the time domain resource of the PDCCH repetition should avoid a symbol location of a corresponding SSB.

For multiplexing mode 3 of SSB and CORESET #0, CORESET #0 resources in which the SSB and the PDCCH repetition are located should be at a same moment in time domain.

Common PDCCH repetition usually specifically refers to SIB1 PDCCH repetition, but other Common PDCCH repetitions are not excluded either.

In some embodiments, transmission of Common PDCCH repetition needs to satisfy one or more of the following rules:
a number of the common PDCCH repetitions should be an integer multiple of one SSB period;
a number of the common PDCCH repetitions should be an integer multiple of one SSB to RO association period; and
transmission of the common PDCCH repetition should be in a determined window/period, for example, drop transmission that is not in the window/period.

The window/period may be at least one of the following: an RAR window, a contention resolution timer, a MsgB response window, an SSB to RO association period, an SSB period, an SIB1 period, a period of SearchSpace, and the like.

In some embodiments, Common PDCCH repetition may be either time-domain PDCCH repetition or frequency-domain PDCCH repetition.

The repetition in time domain may be at least one of the following:
repetition on different PDCCH MOs in same Searchspace of a same CORESET;
repetition in different inter-searchspaces of same or different CORESETs; and
repetition in same intra-searchspace of different CORESETs.

The repetition in frequency domain may be at least one of the following:
repetition on a same PDCCH MO of a same CORESET; and
repetition on a same PDCCH MO of different CORESETs, where
the same PDCCH MO may be located in the same searchspace or different searchspaces, for example, different transmissions are a plurality of copies of a CORESET resource at one moment.

In some embodiments, if a CORESET resource of repetition transmission of a Common PDCCH conflicts with a CORESET resource of first transmission corresponding to another Common PDCCH, this transmission is dropped, and a number of repetitions +1 or not +1.

In some embodiments, the indication method of Common PDCCH repetition may not be effective for all Common PDCCHs. For example, indication of SIB1 PDCCH repetition transmission only supports explicit or implicit indication in SSB, PBCH, or MIB, while indication of Msg4 PDCCH repetition transmission may support any of the above methods.

In some embodiments, a granularity/combination indicated by the repetition information of Common PDCCH repetition includes one or more of the following:
for each Common PDCCH, there may be a corresponding indication for repetition information, that is, the repetition information of each Common PDCCH repetition is indicated independently. For example, there are indications for repetition information of SIB1 PDCCH repetition transmission, repetition information of OSI PDCCH repetition transmission, repetition information of Msg2/4/B PDCCH repetition transmission, repetition information of Paging PDCCH repetition transmission, and repetition information of PDCCH repetition transmission for scheduling Msg3 retransmission; and
all Common PDCCH correspond to only one indication of repetition information, that is, repetition information of different Common PDCCH repetitions is uniformly indicated. For example, repetition information of repetition transmission of a plurality of types of common PDCCHs (such as SIB1 PDCCH, OSI PDCCH, Msg2/4/B PDCCH, Paging PDCCH, and the PDCCH for scheduling Msg3 retransmission) is indicated by indicating repetition information of common PDCCH repetition transmission only once.

In some embodiments, activation/deactivation of Common PDCCH repetition transmission may include one or more of the following:
activation/deactivation through RRC, for example, a system messages configures activation/deactivation;
activation/deactivation by using a MAC CE message;
activation/deactivation by using an RAR (an RAR in 4-step random access, a fallback RAR in 4-step random access, or a success RAR), for example, the RAR indicates whether to support repetition of a subsequent Msg4 PDCCH;
activation/deactivation by using a DCI message, for example, indicating, by using a PDCCH for scheduling SIB1, whether the following RAR PDCCH, Msg4 PDCCH, and paging PDCCH support repetition;
deactivation after the terminal sends Msg3; and
deactivation after the terminal receives a success RAR.

In some embodiments, the MIB or SIB information may be NTN specific MIB/SIB, or may be ordinary MIB/SIB.

### Embodiment 2

This embodiment mainly describes a time sequence relationship of Common PDCCH repetition, and details are as follows.

In some embodiments, a time sequence relationship between Common PDCCH repetition and its scheduled PDSCH includes at least one of the following:
a slot offset of the PDSCH scheduled by Common PDCCH is relative to a slot in which a first transmission of PDCCH repetition is located;
a slot offset of the PDSCH scheduled by Common PDCCH is relative to a slot in which a last transmission of PDCCH repetition is located; and
a slot offset of the PDSCH scheduled by Common PDCCH is relative to a slot in which an n^{th} transmission of PDCCH repetition is located.

N may be configured by a network or determined in advance.

The first transmission/last transmission/n^{th} transmission of the common PDCCH repetition includes at least one of the following:
transmission in a physical slot;
transmission in an available slot;
valid transmission in an RAR window; and
it should be a valid transmission.

If the slot offset value K0=0, it indicates that a transmission of a PDSCH and a transmission of a PDCCH scheduling the PDSCH are in a same slot.

In this case, the relationship between the starting symbol of the PDSCH and the Common PDCCH includes one or more of the following:
the starting symbol of the PDSCH and the starting symbol of the Common PDCCH are separated by N symbols, where N>=0; and
the starting symbol of the PDSCH and a last symbol of the Common PDCCH are separated by N symbols, where N>=0.

A slot offset of the PDSCH scheduled by Common PDCCH is referenced relative to a time point of the RAR/MsgB response window. For example, a reference slot is a 1^{st} slot in which the RAR/MsgB response window is located.

In some embodiments, if Common PDCCH repetition is Msg2 PDCCH repetition, a relationship between Msg2 PDCCH repetition and RAR window includes at least one of the following:
Msg2 PDCCH repetition may be transmitted across the RAR window, for example, as long as a 1^{st} repetition (first transmission) of Msg2 PDCCH is in the RAR window; and
Msg2 PDCCH repetition cannot be transmitted across the RAR window, including one or more of the following methods:
for those that not all repetition resources can be found in the RAR window, those PDCCH resources are not used for PDCCH repetition transmission;
the terminal does not expect Msg2 PDCCH to exceed the RAR window; and
the terminal monitors only some transmissions in the RAR window and drops transmission exceeding the RAR window.

Define a new RAR-repetition window for Msg2 PDCCH repetition transmission. Furthermore, definition of the RAR-repetition window includes one or more of the following:
the RAR-repetition window is used for replacing the RAR window;
the RAR-repetition window takes effect after the RAR window expires; and
duration of the RAR-repetition window is related to associated information of Common PDCCH repetition (for example, a number of repetitions). For example, an actual length of the RAR window is the configured RAR window multiplied by the number of repetitions of Msg2, provided that a total length does not exceed a maximum allowed RAR window length (a maximum RAR window length allowed in a protocol is 10 ms). If a product reaches or exceeds the maximum allowed RAR window length, the length of the RAR window is the maximum allowed RAR window length.

The RAR window extends the duration by N on the basis of the RAR window in the related technology. The duration N may be configured or pre-defined by the network, or may be determined by other factors such as the number of repetitions of Msg2. A unit thereof may be symbol, slot, millisecond, or the like. For example, the duration N herein is an offset.

For example, when the duration N expires, and the terminal has not received Msg2 yet, the terminal considers reception of Msg2 fails.

For example, drop PDCCH repetition that expires more than the duration N.

The starting moment of the RAR window meets one or more of the following conditions:
a 1^{st} symbol of a CORESET that meets a target condition earliest after at least one symbol (or at least one symbol plus T_{TA}+k_{mac}, for specific definition, refer to the definition in the foregoing embodiment) following a last symbol of the PRACH; and
a 1^{st} symbol of a CORESET in which an i^{th} transmission of Msg2 PDCCH repetition is located. In particular, the i^{th} time may be the first time.

For example, defining the starting moment of the RAR window as a 1^{st} symbol of an earliest CORESET that includes 1^{st} repetition of Msg2 PDCCH after at least one symbol (or at least one symbol plus T_{TA}+k_{mac}, for specific definition, refer to the definition in the foregoing embodiment) following a last symbol of a corresponding PRACH; and the extension of duration N on the basis of the RAR window in the related technology further includes that total extended duration (RAR_window_length plus duration N) cannot exceed duration M. If the total duration exceeds the duration M, it is considered as the duration M. Specifically, the duration M may be 10 ms, or other values predefined by the network.

In some embodiments, if Common PDCCH repetition is Msg4 PDCCH repetition, a relationship between Msg4 PDCCH repetition and contention resolution timer includes at least one of the following:
Msg4 PDCCH repetition may be transmitted across the contention resolution timer, for example, as long as a 1^{st} repetition (first transmission) of Msg4 PDCCH is in the contention resolution timer; and
Msg4 PDCCH repetition cannot be transmitted across the contention resolution timer, for example, including one or more of the following methods:
for those that not all transmission resources of Msg4 PDCCH repetition can be found in the contention resolution timer, a PDCCH resource outside the contention resolution timer is not used for PDCCH repetition transmission;
the terminal does not expect a Msg4 PDCCH repetition resource to exceed the contention resolution timer; and
the terminal receives only some transmissions in the contention resolution timer and drops transmission exceeding the contention resolution timer.

Define a new timer for Msg4 PDCCH repetition transmission. Furthermore, definition of the timer includes one or more of the following:
the timer is used for replacing the contention resolution timer;
the timer takes effect after the contention resolution timer expires; and
duration of the timer is related to associated information of Common PDCCH repetition (for example, a number of repetitions). For example, an actual length of the contention resolution timer is the configured contention resolution timer multiplied by the number of repetitions of Msg4 PDCCH, provided that a total length does not exceed a maximum allowed contention resolution timer length. If a product reaches or exceeds the maximum allowed contention resolution timer length, the length of the contention resolution timer is the maximum allowed contention resolution timer length.

The content resolution timer of the Msg4 PDCCH repetition is extended by duration N based on the content resolution timer defined in the protocol, and the duration N may be configured by the network or predefined or determined by other factors, such as the number of Msg4 repetitions, and a unit thereof may be symbol, slot, millisecond, or the like. For example, the duration N is one slot offset.

In addition, when the duration N expires, and the terminal has not received Msg4 yet, the terminal may consider contention resolution fails, for example, the terminal may drop PDCCH repetition that expires more than the duration N.

The starting moment of the contention resolution timer may be at least one of the following:
a 1^{st} symbol after associated Msg3 transmission (including all Msg3 repetitions if the Msg3 repetitions are supported) ends (or in a case of NTN, the 1^{st} symbol plus RTT of the terminal and the network side device); and
a moment X after associated Msg3 transmission (including all Msg3 repetitions if the Msg3 repetitions are supported) ends, where the moment X may be at least one of the following:
a 1^{st} symbol of a next slot;
a 1^{st} symbol of a slot in which an earliest CORESET is located; and
a 1^{st} symbol of a CORESET that meets a target condition earliest after at least one symbol, where
the target condition is a 1^{st} symbol of a CORESET in which an i^{th} transmission of Msg4 PDCCH repetition is located. Herein, i may be configured by the network or predefined. In particular, the i^{th} time may be the first time. For example, if i is 1, the starting moment of the contention resolution timer is defined as a 1^{st} symbol of an earliest CORESET including a 1st repetition of Msg4 PDCCH after at least one symbol (or in a case of NTN, the 1^{st} symbol plus UE-gNB RTT) after the end of the associated Msg3 transmission (including all Msg3 repetitions if the Msg3 repetitions are supported).

For another example, in a case of NTN, an interval between an end moment of the associated Msg3 transmission (including all Msg3 repetitions if the Msg3 repetitions are supported) and the starting moment of the contention resolution timer is at least equal to or greater than RTT duration between the terminal and the network side device; and if the interval is less than the RTT duration between the terminal and the network side device, the starting moment of the contention resolution timer is the end moment of the associated Msg3 transmission (including all Msg3 repetitions if the Msg3 repetitions are supported) plus the UE-gNB RTT duration.

In some embodiments, if Common PDCCH repetition is MsgB repetition, a relationship between MsgB PDCCH repetition and MsgB response window includes at least one of the following:
MsgB PDCCH repetition may be transmitted across the MsgB response window, for example, as long as a 1^{st} repetition (first transmission) of MsgB PDCCH is in the MsgB response window; and
MsgB PDCCH repetition cannot be transmitted across the MsgB response window, including one or more of the following methods:
for those that not all transmission resources of MsgB PDCCH repetition can be found in the MsgB response window, a PDCCH resource outside the MsgB response window is not used for PDCCH repetition transmission;
the terminal does not expect MsgB PDCCH to exceed the MsgB response window; and
the terminal monitors only some repetitions in the MsgB response window and drops repetition exceeding the MsgB response window.

Alternatively, define a new window for MsgB PDCCH repetition transmission. Furthermore, definition of the new window includes one or more of the following:
the new window is used for replacing the MsgB response window;
the new window takes effect after the MsgB response window expires; and
duration of the new window is related to associated information of Common PDCCH repetition (for example, a number of transmissions). For example, an actual length of the MsgB response window is the configured MsgB response window multiplied by the number of repetitions of MsgB, provided that a total length does not exceed a maximum allowed MsgB response window length (a currently allowed maximum MsgB response window length is 40 ms). If a product reaches or exceeds the maximum allowed MsgB response window length, the length of the MsgB response window is the maximum allowed MsgB response window length.

Alternatively, the MsgB response window of the MsgB PDCCH repetition is increased by duration N on the basis of the MsgB response window defined in the protocol. The duration N may be configured by the network, predefined, or determined by other factors such as the number of Msg4 repetitions, and a unit thereof may be symbol, slot, millisecond, or the like.

For example, when the duration N expires, and the terminal has not received MsgB yet, the terminal may fall back to MsgA for retransmission.

For another example, drop PDCCH repetition that expires more than the duration N.

The starting moment of the MsgB response window may be at least one of the following:
a 1^{st} symbol of a CORESET in which a 1^{st} repetition transmission of MsgB PDCCH repetition is located;
a 1^{st} symbol of a CORESET in which a last repetition transmission of MsgB PDCCH repetition is located;
a 1^{st} symbol of a CORESET in which an i^{th} transmission of MsgB PDCCH repetition is located;
a 1^{st} symbol of an earliest CORESET after at least one symbol (or at least one symbol plus T_{TA}+k_{mac}, for specific definition, refer to the foregoing embodiment) following a last symbol of a PUSCH occasion of a corresponding PRACH; and a 1^{st} symbol of a CORESET that meets a target condition earliest after at least one symbol (or at least one symbol plus T_{TA}+k_{mac}, for specific definition, refer to the foregoing embodiment) following at least one symbol of a last symbol of a PUSCH occasion of a corresponding PRACH, where the target condition is a 1^{st} symbol of a CORESET in which an i^{th} repetition transmission that satisfies MsgB PDCCH repetition is located. In particular, the i^{th} time may be the first time or the last time. For example, defining the starting moment of the MsgB response window as a 1^{st} symbol of an earliest CORESET that includes 1^{st} repetition of MsgB PDCCH after at least one symbol (or at least one symbol plus T_{TA}+k_{mac}) following at least symbol after a last symbol of a PUSCH transmission occasion corresponding to the PRACH. The PRACH refers to a MsgA PRACH part, and the corresponding PUSCH refers to a MsgA PUSCH part.

In some embodiments, deactivation of Common PDCCH repetition transmission may include one or more of the following:
deactivation after the UE sends Msg3;
deactivation after the UE receives a success RAR;
deactivation of the RAR window;
deactivation of a maximum allowed RAR window;
deactivation by a network configuration;
deactivation after Contention resolution timer expires; and
deactivation after Msg4/MsgB is decoded successfully.

This embodiment of this application may be applied to enhancement of Common PDCCH in the NTN scenario, may also be applied to enhancement of Common PDCCH in the TN network, and may be applied to enhancement of all Common PDCCHs before the terminal enters the RRC connection state.

This embodiment of this application solves a coverage problem of Common PDCCH in some scenarios by configuring common PDCCH repetition transmission, thereby ensuring a success rate of random access and improving an overall coverage of the network.

The method for processing PDCCH repetition transmission provided in this embodiment of this application may be executed by an apparatus for processing PDCCH repetition transmission. In this embodiment of this application, an example in which the apparatus for processing PDCCH repetition transmission performs the method for processing PDCCH repetition transmission is used to describe the apparatus for processing PDCCH repetition transmission provided in this embodiment of this application.

Referring to FIG. 4, FIG. 4 is a structural diagram of an apparatus for processing PDCCH repetition transmission according to an embodiment of this application. As shown in FIG. 4, an apparatus 400 for processing PDCCH repetition transmission includes:
an obtaining module 401, configured to obtain configuration information of common PDCCH repetition transmission; and
a receiving module 402, configured to receive the common PDCCH repetition transmission based on the configuration information, where the common PDCCH includes at least one of the following:
a system information block (SIB) 1 PDCCH, an OSI PDCCH, a message 2 PDCCH, a message 4 PDCCH, a message B PDCCH, a paging PDCCH, and a PDCCH for scheduling message 3 retransmission.

Optionally, the configuration information includes at least one of the following parameters:
a function of the common PDCCH repetition transmission;
a number of repetitions of the common PDCCH repetition transmission;
an index of the common PDCCH repetition transmission;
resource information of the common PDCCH repetition transmission;
activation information of the common PDCCH repetition transmission, the activation information representing activation or deactivation of the common PDCCH repetition transmission; and
a repetition mode of the common PDCCH repetition transmission.

Optionally, the resource information of the common PDCCH repetition transmission includes at least one of the following:
a pattern of the common PDCCH repetition transmission, the pattern indicating a resource location occupied by the common PDCCH repetition transmission;
indication information for indicating that the common PDCCH repetition transmission is performed based on an available slot; and
indication information for indicating that the common PDCCH repetition transmission is performed based on a physical slot.

Optionally, the repetition mode of the common PDCCH repetition transmission includes at least one of the following:
intra-slot repetition transmission; and
inter-slot repetition transmission.

Optionally, the obtaining module 401 is configured to determine the configuration information of the common PDCCH repetition transmission based on indication information, and the indication information includes at least one of the following:
a synchronization signal block (SSB), a master information block (MIB), a physical broadcast channel (PBCH), a system information block (SIB), a radio network temporary identifier (RNTI), a control resource set (CORESET) configuration table, a monitoring occasion table of a common search space (CSS), a downlink channel receiving window, a downlink channel transmission period, a CORESET resource, a search space, a physical downlink control channel (PDCCH) monitoring occasion (MO), a physical random access channel (PRACH) resource, an SIB1 PDCCH, a message 2, a message B, a message 2 PDCCH, a message B PDCCH, a PDCCH for scheduling message 3 retransmission, radio resource control (RRC) signaling, a medium access control control element (MAC CE), a random access response, downlink control information (DCI), and a message 3.

Optionally, the obtaining module 401 is configured to determine at least some parameters in the configuration information of the common PDCCH repetition transmission based on at least one of a demodulation reference signal (DMRS) sequence of the PBCH, a DMRS pattern of the PBCH, a DMRS time domain resource of the PBCH, a DMRS frequency domain resource of the PBCH, a scrambling sequence of the PBCH, and a payload of the PBCH.

Optionally, the RNTI includes a first RNTI defined for the common PDCCH repetition transmission, and the first RNTI is used for scrambling downlink control information (DCI) related to the common PDCCH, where
a generation manner of the first RNTI includes at least one of the following:
being generated based on a random access radio network temporary identifier (RA-RNTI) and an offset;
being generated based on a system information radio network temporary identifier (SI-RNTI) and an offset;
being generated based on a temporary cell radio network temporary identifier (TC-RNTI) and an offset;
being generated based on a paging radio network temporary identifier (P-RNTI) and an offset; and
being generated based on a message B radio network temporary identifier (MsgB-RNTI) and an offset, where
the offset is associated with the configuration information of the common PDCCH repetition transmission.

Optionally, the CORESET configuration table includes a first CORESET configuration table, the first CORESET configuration table is a CORESET resource configuration table for a type0-PDCCH search space set, and different resource configurations in the first CORESET configuration table correspond to respective configuration parameters of common PDCCH repetition transmission; or the CORESET configuration table includes a second CORESET configuration table, the second CORESET configuration table is a CORESET resource configuration table defined for the common PDCCH repetition transmission, and different indexes in the second CORESET configuration table correspond to respective configuration parameters of common PDCCH repetition transmission, where the configuration parameters of the common PDCCH repetition transmission are at least some parameters included in the configuration information of the common PDCCH repetition transmission;
or
the monitoring occasion table of the CSS includes a monitoring occasion table of a first CSS, the monitoring occasion table of the first CSS is a PDCCH monitoring occasion table for a type0-PDCCH search space set, and parameters of different PDCCH monitoring occasions in the monitoring occasion table of the first CSS correspond to respective configuration parameters of common PDCCH repetition transmission; or the monitoring occasion table of the CSS includes a monitoring occasion table of a second CSS, the monitoring occasion table of the second CSS is a CSS monitoring occasion table defined for the common PDCCH repetition transmission, and different indexes in the monitoring occasion table of the second CSS correspond to respective configuration parameters of common PDCCH repetition transmission, where the configuration parameters of the common PDCCH repetition transmission are at least some parameters included in the configuration information of the common PDCCH repetition transmission.

Optionally, a number of resources existing in the downlink channel receiving window is associated with some or all parameters in the configuration information, and the number of resources includes at least one of the following: a number of CORESETs, a number of search spaces, and a number of PDCCH MOs;
or
a transmission resource of the common PDCCH repetition transmission is located in the downlink channel receiving window;
or
a number of resources existing within the downlink channel transmission period is associated with some or all parameters in the configuration information, and the number of resources includes at least one of the following: a number of CORESETs, a number of search spaces, and a number of PDCCH MOs;
or
a transmission resource of the common PDCCH repetition transmission is located within the downlink channel transmission period.

Optionally, the downlink channel receiving window includes at least one of the following:
a window configured for the common PDCCH repetition transmission, a receiving window of a downlink channel defined in a protocol, and a window determined based on a downlink channel transmission parameter;
or
a downlink channel receiving period includes at least one of the following:
a period configured for the common PDCCH repetition transmission, a receiving period of a downlink channel defined in a protocol, and a period determined based on a downlink channel transmission parameter.

Optionally, the common PDCCH repetition transmission satisfies at least one of the following:
a time domain resource of the common PDCCH repetition transmission in CORESET #0 does not overlap with a time domain resource of an associated synchronization signal block (SSB); or a time domain resource of the common PDCCH repetition transmission in CORESET #0 overlaps with a time domain resource of an associated SSB;
the common PDCCH repetition transmission has a same number of transmissions within a plurality of SSB periods;
the common PDCCH repetition transmission has a same number of transmissions within a plurality of first periods, and the first period is a period within which an SSB is associated with an RO;
the common PDCCH repetition transmission is located in the downlink channel receiving window; and
the common PDCCH repetition transmission is located within the downlink channel transmission period.

Optionally, the common PDCCH repetition transmission includes repetition transmission in time domain, and repetition transmission of the common PDCCH in time domain includes at least one of the following:
repetition transmission of the common PDCCH on different PDCCH MOs in a same search space of a same CORESET;
repetition transmission of the common PDCCH in different search spaces of a same CORESET;
repetition transmission of the common PDCCH in different search spaces of different CORESETs; and
repetition transmission of the common PDCCH in a same search space of different CORESETs;
or
the common PDCCH repetition transmission includes repetition transmission in frequency domain, and repetition transmission of the common PDCCH in frequency domain includes at least one of the following:
repetition transmission of the common PDCCH on a same PDCCH MO of a same CORESET; and
repetition transmission of the common PDCCH on a same PDCCH MO of different CORESETs.

Optionally, the apparatus further includes:
a dropping module, configured to drop reception of repetition transmission of the common PDCCH in a case that a resource for repetition transmission of the common PDCCH conflicts with a resource for a first transmission of another common PDCCH.

Optionally, an execution module 402 is configured to perform the PDCCH repetition transmission based on the configuration information of the PDCCH repetition transmission and timeline information of the common PDCCH repetition transmission, and the timeline information of the common PDCCH repetition transmission includes at least one of the following:
a time sequence relationship between the common PDCCH repetition transmission and a physical downlink shared channel (PDSCH) scheduled by a common PDCCH;
a time relationship between the common PDCCH repetition transmission and an RAR receiving window;
a time relationship between the common PDCCH repetition transmission and a contention resolution timer; and
a time relationship between the common PDCCH repetition transmission and a message B-response window.

Optionally, the time sequence relationship between the common PDCCH repetition transmission and the PDSCH scheduled by the common PDCCH includes one of the following:
a slot offset of the PDSCH scheduled by the common PDCCH is an offset relative to a slot in which a first transmission of the common PDCCH repetition transmission is located;
a slot offset of the PDSCH scheduled by the common PDCCH is a slot offset relative to a slot in which a last transmission of the common PDCCH repetition transmission is located;
a slot offset of the PDSCH scheduled by the common PDCCH is a slot offset relative to a slot in which an n^{th} transmission of the common PDCCH repetition transmission is located, and a value of n is configured by a network side or specified in a protocol; and
a slot offset of the PDSCH scheduled by the common PDCCH is an offset relative to a target time point of a receiving window associated with the common PDCCH repetition transmission.

Optionally, the first transmission of the common PDCCH includes one of the following:
a first transmission of the common PDCCH repetition transmission in a physical slot;
a first transmission of the common PDCCH repetition transmission in an available slot;
a first transmission of the common PDCCH repetition transmission in the RAR receiving window;
a first transmission of the common PDCCH repetition transmission in the message B-response window; and
a first valid transmission of the common PDCCH repetition transmission;
or
the last transmission of the common PDCCH repetition transmission includes one of the following:
a last transmission of the common PDCCH repetition transmission in a physical slot;
a last transmission of the common PDCCH repetition transmission in an available slot;
a last transmission of the common PDCCH repetition transmission in the RAR
a last transmission of the common PDCCH repetition transmission in the message B-response window; and
a last valid transmission of the common PDCCH repetition transmission;
or
the n^{th} transmission of the common PDCCH repetition transmission includes one of the following:
an n^{th} transmission of the common PDCCH repetition transmission in a physical slot;
an n^{th} transmission of the common PDCCH repetition transmission in an available slot;
an n^{th} transmission of the common PDCCH repetition transmission in the RAR receiving window;
an n^{th} transmission of the common PDCCH repetition transmission in the message B-response window; and
an n^{th} valid transmission of the common PDCCH repetition transmission.

Optionally, the time relationship between the common PDCCH repetition transmission and the RAR receiving window includes one of the following:
the common PDCCH repetition transmission is allowed to cross the RAR receiving window, and the common PDCCH repetition transmission is not allowed to cross the RAR receiving window;
or
the time relationship between the common PDCCH repetition transmission and a contention resolution timer includes one of the following:
the common PDCCH repetition transmission is allowed to cross the contention resolution timer, and the common PDCCH repetition transmission is not allowed to cross the contention resolution timer;
or
the time relationship between the common PDCCH repetition transmission and a message B-response window includes one of the following:
the common PDCCH repetition transmission is allowed to cross the message B-response window, and the common PDCCH repetition transmission is not allowed to cross the message B-response window.

Optionally, the RAR receiving window includes: an RAR receiving window available for the common PDCCH repetition transmission; or an RAR receiving window that is obtained after an offset is added to an RAR receiving window not available for the common PDCCH repetition transmission;
or
the message B-response window includes:
a message B-response window available for the common PDCCH repetition transmission; or a message B-response window that is obtained after an offset is added to a message B-response window not available for the common PDCCH repetition transmission;
or
the contention resolution timer includes:
a defined contention resolution timer available for the common PDCCH repetition transmission; or a contention resolution timer that is obtained after an offset is added to a contention resolution timer not available for the common PDCCH repetition transmission.

Optionally, a starting moment of the RAR receiving window includes:
a 1^{st} symbol of a CORESET that meets a target condition earliest in a first resource, where
the first resource includes:
a resource that is located after a last symbol occupied by a PRACH and that is separated from the last symbol occupied by the PRACH by at least one symbol; or
a resource that is located after a last symbol occupied by a PRACH and that is separated from the last symbol occupied by the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

Optionally, a starting moment of the contention resolution timer includes a first moment after an end of transmission of the message 3, or an interval between a starting moment of the contention resolution timer and a transmission end moment of the message 3 is equal to or greater than a round trip time (RTT), where the first moment includes at least one of the following:
a 1^{st} symbol of a next slot after the end of transmission of the message 3;
a 1^{st} symbol of an earliest CORESET after the end of transmission of the message 3; and
a 1^{st} symbol of a CORESET that meets a target condition earliest in a second resource, where
the second resource includes:
a resource that is separated from the end of transmission of the message 3 by at least one symbol after the end of transmission of the message 3.

Optionally, a starting moment of the message B-response window includes at least one of the following:
a 1^{st} symbol of a CORESET in which the first transmission of the common PDCCH repetition transmission is located;
a 1^{st} symbol of a CORESET in which the last transmission of the common PDCCH repetition transmission is located;
a 1^{st} symbol of a CORESET in which an i^{th} transmission of the common PDCCH repetition transmission is located, a value of i being equal to or greater than 1 and less than or equal to a number of repetitions of the common PDCCH;
a 1^{st} symbol of an earliest CORESET in a third resource; and
a 1^{st} symbol of a CORESET that meets a target condition earliest in a third resource, where
the third resource includes:
a resource that is located after a last symbol of a physical uplink shared channel (PUSCH) occasion corresponding to a PRACH and that is separated from the last symbol of the PUSCH occasion corresponding to the PRACH by at least one symbol; or
a resource that is located after a last symbol of a PUSCH occasion corresponding to a PRACH and that is separated from the last symbol of the PUSCH occasion corresponding to the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

Optionally, the CORESET that meets a target condition includes:
a CORESET in which an i^{th} transmission of the common PDCCH repetition transmission is located, a value of i being equal to or greater than 1 and less than or equal to the number of repetitions of the common PDCCH.

Optionally, the method further includes:
a deactivating module, configured to deactivate the common PDCCH repetition transmission when any one of the following is met:
the terminal sends the message 3;
the terminal receives a success RAR;
the RAR receiving window ends;
a maximum allowed RAR window ends;
the contention resolution timer expires;
a message 4 is decoded successfully;
the message B is decoded successfully; and
a network side configuration performs deactivation.

Optionally, in a case that the i^{th} transmission of the common PDCCH repetition transmission and the PDSCH scheduled by the common PDCCH are in a same slot, a relationship between a starting symbol of the PDSCH scheduled by the common PDCCH and the common PDCCH repetition transmission includes at least one of the following:
the starting symbol of the PDSCH scheduled by the common PDCCH is separated from a starting symbol of the i^{th} transmission of the common PDCCH repetition transmission by N symbols; and
the starting symbol of the PDSCH scheduled by the common PDCCH is separated from a symbol of the i^{th} transmission of the common PDCCH repetition transmission by N symbols, where
the value of i is equal to or greater than 1, and less than or equal to the number of repetitions of the common PDCCH, and N is greater than or equal to 0.

The apparatus for processing PDCCH repetition transmission may improve coverage performance of the network.

The apparatus for processing PDCCH repetition transmission in this embodiment of this application may be an electronic device, for example, an electronic device with an operating system, or may be a component in the electronic device, for example, an integrated circuit or a chip. For example, the electronic device may be a terminal, or another device other than the terminal. For example, the terminal may include but is not limited to the types of terminals listed in this embodiment of this application, and the another device may be a server, a network attached storage (NAS), or the like. This is not specifically limited in this embodiment of this application.

The apparatus for processing PDCCH repetition transmission provided in this embodiment of this application can implement the processes implemented in the method embodiment of FIG. 2, and achieve a same technical effect. To avoid repetition, details are not described herein again.

Referring to FIG. 5, FIG. 5 is a structural diagram of an apparatus for processing PDCCH repetition transmission according to an embodiment of this application. As shown in FIG. 5, an apparatus 500 for processing PDCCH repetition transmission includes:
a sending module 501, configured to send configuration information of common PDCCH repetition transmission to a terminal; and
an execution module 502, configured to perform the common PDCCH repetition transmission based on the configuration information, where
the common PDCCH includes at least one of the following:
a system information block (SIB) 1 PDCCH, an OSI PDCCH, a message 2 PDCCH, a message 4 PDCCH, a message B PDCCH, a paging PDCCH, and a PDCCH for scheduling message 3 retransmission.

Optionally, the configuration information includes at least one of the following parameters:
a function of the common PDCCH repetition transmission;
a number of repetitions of the common PDCCH repetition transmission;
an index of the common PDCCH repetition transmission;
resource information of the common PDCCH repetition transmission;
activation information of the common PDCCH repetition transmission, the activation information representing activation or deactivation of the common PDCCH repetition transmission; and
a repetition mode of the common PDCCH repetition transmission.

Optionally, the resource information of the common PDCCH repetition transmission includes at least one of the following:
a pattern of the common PDCCH repetition transmission, the pattern indicating a resource location occupied by the common PDCCH repetition transmission;
indication information for indicating that the common PDCCH repetition transmission is performed based on an available slot; and
indication information for indicating that the common PDCCH repetition transmission is performed based on a physical slot.

Optionally, the repetition mode of the common PDCCH repetition transmission includes at least one of the following:
intra-slot repetition transmission; and
inter-slot repetition transmission.

Optionally, the sending module 501 is configured to send indication information to the terminal, the indication information is used for determining the configuration information of the common PDCCH repetition transmission, and the indication information includes at least one of the following:
a synchronization signal block (SSB), a master information block (MIB), a physical broadcast channel (PBCH), a system information block (SIB), a radio network temporary identifier (RNTI), a control resource set (CORESET) configuration table, a monitoring occasion table of a common search space (CSS), a downlink channel receiving window, a downlink channel transmission period, a CORESET resource, a search space, a physical downlink control channel (PDCCH) monitoring occasion (MO), a physical random access channel (PRACH) resource, an SIB1 PDCCH, a message 2, a message B, a message 2 PDCCH, a message B PDCCH, a PDCCH for scheduling message 3 retransmission, radio resource control (RRC) signaling, a medium access control control element (MAC CE), a random access response, downlink control information (DCI), and a message 3.

Optionally, at least one of the following items in the PBCH is used for indicating some or all of the configuration information:
a demodulation reference signal (DMRS) of the PBCH, a scrambling sequence of the PBCH, and a payload of the PBCH, where
the DMRS includes at least one of the following: a DMRS sequence, a DMRS pattern, a DMRS time domain resource, and a DMRS frequency domain resource.

Optionally, the RNTI includes a first RNTI defined for the common PDCCH repetition transmission, and the first RNTI is used for scrambling downlink control information (DCI) related to the common PDCCH, where
a generation manner of the first RNTI includes at least one of the following:
being generated based on a random access radio network temporary identifier (RA-RNTI) and an offset;
being generated based on a system information radio network temporary identifier (SI-RNTI) and an offset;
being generated based on a temporary cell radio network temporary identifier (TC-RNTI) and an offset;
being generated based on a paging radio network temporary identifier (P-RNTI) and an offset; and
being generated based on a message B radio network temporary identifier (MsgB-RNTI) and an offset, where
the offset is associated with the configuration information of the common PDCCH repetition transmission.

Optionally, the CORESET configuration table includes a first CORESET configuration table, the first CORESET configuration table is a CORESET resource configuration table for a type0-PDCCH search space set, and different resource configurations in the first CORESET configuration table correspond to respective configuration parameters of common PDCCH repetition transmission; or the CORESET configuration table includes a second CORESET configuration table, the second CORESET configuration table is a CORESET resource configuration table defined for the common PDCCH repetition transmission, and different indexes in the second CORESET configuration table correspond to respective configuration parameters of common PDCCH repetition transmission, where the configuration parameters of the common PDCCH repetition transmission are at least some parameters included in the configuration information of the common PDCCH repetition transmission;
or
the monitoring occasion table of the CSS includes a monitoring occasion table of a first CSS, the monitoring occasion table of the first CSS is a PDCCH monitoring occasion table for a type0-PDCCH search space set, and parameters of different PDCCH monitoring occasions in the monitoring occasion table of the first CSS correspond to respective configuration parameters of common PDCCH repetition transmission; or the monitoring occasion table of the CSS includes a monitoring occasion table of a second CSS, the monitoring occasion table of the second CSS is a CSS monitoring occasion table defined for the common PDCCH repetition transmission, and different indexes in the monitoring occasion table of the second CSS correspond to respective configuration parameters of common PDCCH repetition transmission, where the configuration parameters of the common PDCCH repetition transmission are at least some parameters included in the configuration information of the common PDCCH repetition transmission.

Optionally, a number of resources existing in the downlink channel receiving window is associated with some or all parameters in the configuration information, and the number of resources includes at least one of the following: a number of CORESETs, a number of search spaces, and a number of PDCCH MOs;
or
a transmission resource of the common PDCCH repetition transmission is located in the downlink channel receiving window;
or
a number of resources existing within the downlink channel transmission period is associated with some or all parameters in the configuration information, and the number of resources includes at least one of the following: a number of CORESETs, a number of search spaces, and a number of PDCCH MOs;
or
a transmission resource of the common PDCCH repetition transmission is located within the downlink channel transmission period.

Optionally, the downlink channel receiving window includes at least one of the following:
a window configured for the common PDCCH repetition transmission, a receiving window of a downlink channel defined in a protocol, and a window determined based on a downlink channel transmission parameter;
or
a downlink channel receiving period includes at least one of the following:
a period configured for the common PDCCH repetition transmission, a receiving period of a downlink channel defined in a protocol, and a period determined based on a downlink channel transmission parameter.

Optionally, the common PDCCH repetition transmission satisfies at least one of the following:
a time domain resource of the common PDCCH repetition transmission in CORESET #0 does not overlap with a time domain resource of an associated synchronization signal block (SSB); or a time domain resource of the common PDCCH repetition transmission in CORESET #0 overlaps with a time domain resource of an associated SSB;
the common PDCCH repetition transmission has a same number of transmissions within a plurality of SSB periods;
the common PDCCH repetition transmission has a same number of transmissions within a plurality of first periods, and the first period is a period within which an SSB is associated with an RO;
the common PDCCH repetition transmission is located in the downlink channel receiving window; and
the common PDCCH repetition transmission is located within the downlink channel transmission period.

Optionally, the common PDCCH repetition transmission includes repetition transmission in time domain, and repetition transmission of the common PDCCH in time domain includes at least one of the following:
repetition transmission of the common PDCCH on different PDCCH MOs in a same search space of a same CORESET;
repetition transmission of the common PDCCH in different search spaces of a same CORESET;
repetition transmission of the common PDCCH in different search spaces of different CORESETs; and
repetition transmission of the common PDCCH in a same search space of different CORESETs;
or
the common PDCCH repetition transmission includes repetition transmission in frequency domain, and repetition transmission of the common PDCCH in frequency domain includes at least one of the following:
repetition transmission of the common PDCCH on a same PDCCH MO of a same CORESET; and
repetition transmission of the common PDCCH on a same PDCCH MO of different CORESETs.

Optionally, the apparatus further includes:
a dropping module, configured to drop repetition transmission of the common PDCCH in a case that a resource for repetition transmission of the common PDCCH conflicts with a resource for a first transmission of another common PDCCH.

Optionally, an execution module 502 is configured to perform the PDCCH repetition transmission based on the configuration information of the PDCCH repetition transmission and timeline information of the common PDCCH repetition transmission, and the timeline information of the common PDCCH repetition transmission includes at least one of the following:
a time sequence relationship between the common PDCCH repetition transmission and a physical downlink shared channel (PDSCH) scheduled by a common PDCCH;
a time relationship between the common PDCCH repetition transmission and an RAR receiving window;
a time relationship between the common PDCCH repetition transmission and a contention resolution timer; and
a time relationship between the common PDCCH repetition transmission and a message B-response window.

Optionally, the time sequence relationship between the common PDCCH repetition transmission and the PDSCH scheduled by the common PDCCH includes one of the following:
a slot offset of the PDSCH scheduled by the common PDCCH is an offset relative to a slot in which a first transmission of the common PDCCH repetition transmission is located;
a slot offset of the PDSCH scheduled by the common PDCCH is a slot offset relative to a slot in which a last transmission of the common PDCCH repetition transmission is located;
a slot offset of the PDSCH scheduled by the common PDCCH is a slot offset relative to a slot in which an n^{th} transmission of the common PDCCH repetition transmission is located, and a value of n is configured by a network side or specified in a protocol; and
a slot offset of the PDSCH scheduled by the common PDCCH is an offset relative to a target time point of a receiving window associated with the common PDCCH repetition transmission.

Optionally, the first transmission of the common PDCCH includes one of the following:
a first transmission of the common PDCCH repetition transmission in a physical slot;
a first transmission of the common PDCCH repetition transmission in an available slot;
a first transmission of the common PDCCH repetition transmission in the RAR receiving window;
a first transmission of the common PDCCH repetition transmission in the message B-response window; and
a first valid transmission of the common PDCCH repetition transmission;
or
the last transmission of the common PDCCH repetition transmission includes one of the following:
a last transmission of the common PDCCH repetition transmission in a physical slot;
a last transmission of the common PDCCH repetition transmission in an available slot;
a last transmission of the common PDCCH repetition transmission in the RAR receiving window;
a last transmission of the common PDCCH repetition transmission in the message B-response window; and
a last valid transmission of the common PDCCH repetition transmission;
or
the n^{th} transmission of the common PDCCH repetition transmission includes one of the following:
an n^{th} transmission of the common PDCCH repetition transmission in a physical slot;
an n^{th} transmission of the common PDCCH repetition transmission in an available slot;
an n^{th} transmission of the common PDCCH repetition transmission in the RAR receiving window;
an n^{th} transmission of the common PDCCH repetition transmission in the message B-response window; and
an n^{th} valid transmission of the common PDCCH repetition transmission.

Optionally, the time relationship between the common PDCCH repetition transmission and the RAR receiving window includes one of the following:
the common PDCCH repetition transmission is allowed to cross the RAR receiving window, and the common PDCCH repetition transmission is not allowed to cross the RAR receiving window;
or
the time relationship between the common PDCCH repetition transmission and a contention resolution timer includes one of the following:
the common PDCCH repetition transmission is allowed to cross the contention resolution timer, and the common PDCCH repetition transmission is not allowed to cross the contention resolution timer;
or
the time relationship between the common PDCCH repetition transmission and a message B-response window includes one of the following:
the common PDCCH repetition transmission is allowed to cross the message B-response window, and the common PDCCH repetition transmission is not allowed to cross the message B-response window.

Optionally, the RAR receiving window includes: an RAR receiving window available for the common PDCCH repetition transmission; or an RAR receiving window that is obtained after an offset is added to an RAR receiving window not available for the common PDCCH repetition transmission;
or
the message B-response window includes:
a message B-response window available for the common PDCCH repetition transmission; or a message B-response window that is obtained after an offset is added to a message B-response window not available for the common PDCCH repetition transmission;
or
the contention resolution timer includes:
a defined contention resolution timer available for the common PDCCH repetition transmission; or a contention resolution timer that is obtained after an offset is added to a contention resolution timer not available for the common PDCCH repetition transmission.

Optionally, a starting moment of the RAR receiving window includes:
a 1^{st} symbol of a CORESET that meets a target condition earliest in a first resource, where
the first resource includes:
a resource that is located after a last symbol occupied by a PRACH and that is separated from the last symbol occupied by the PRACH by at least one symbol; or
a resource that is located after a last symbol occupied by a PRACH and that is separated from the last symbol occupied by the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

Optionally, a starting moment of the contention resolution timer includes a first moment after an end of transmission of the message 3, or an interval between a starting moment of the contention resolution timer and a transmission end moment of the message 3 is equal to or greater than a round trip time (RTT), where the first moment includes at least one of the following:
a 1^{st} symbol of a next slot after the end of transmission of the message 3;
a 1^{st} symbol of an earliest CORESET after the end of transmission of the message 3; and
a 1^{st} symbol of a CORESET that meets a target condition earliest in a second resource, where
the second resource includes:
a resource that is separated from the end of transmission of the message 3 by at least one symbol after the end of transmission of the message 3.

Optionally, a starting moment of the message B-response window includes at least one of the following:
a 1^{st} symbol of a CORESET in which the first transmission of the common PDCCH repetition transmission is located;
a 1^{st} symbol of a CORESET in which the last transmission of the common PDCCH repetition transmission is located;
a 1^{st} symbol of a CORESET in which an i^{th} transmission of the common PDCCH repetition transmission is located, a value of i being equal to or greater than 1 and less than or equal to a number of repetitions of the common PDCCH;
a 1^{st} symbol of an earliest CORESET in a third resource; and
a 1^{st} symbol of a CORESET that meets a target condition earliest in a third resource, where
the third resource includes:

a resource that is located after a last symbol of a physical uplink shared channel (PUSCH) occasion corresponding to a PRACH and that is separated from the last symbol of the PUSCH occasion corresponding to the PRACH by at least one symbol; or a resource that is located after a last symbol of a PUSCH occasion corresponding to a PRACH and that is separated from the last symbol of the PUSCH occasion corresponding to the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

Optionally, the CORESET that meets a target condition includes:
a CORESET in which an i^{th} transmission of the common PDCCH repetition transmission is located, a value of i being equal to or greater than 1 and less than or equal to the number of repetitions of the common PDCCH.

Optionally, the method further includes:
a deactivating module, configured to deactivate the common PDCCH repetition transmission when any one of the following is met:
the terminal sends the message 3;
the terminal receives a success RAR;
the RAR receiving window ends;
a maximum allowed RAR window ends;
the contention resolution timer expires;
a message 4 is decoded successfully;
the message B is decoded successfully; and
a network side configuration performs deactivation.

Optionally, in a case that the i^{th} transmission of the common PDCCH repetition transmission and the PDSCH scheduled by the common PDCCH are in a same slot, a relationship between a starting symbol of the PDSCH scheduled by the common PDCCH and the common PDCCH repetition transmission includes at least one of the following:
the starting symbol of the PDSCH scheduled by the common PDCCH is separated from a starting symbol of the i^{th} transmission of the common PDCCH repetition transmission by N symbols; and
the starting symbol of the PDSCH scheduled by the common PDCCH is separated from a symbol of the i^{th} transmission of the common PDCCH repetition transmission by N symbols, where
the value of i is equal to or greater than 1, and less than or equal to the number of repetitions of the common PDCCH, and N is greater than or equal to 0.

The apparatus for processing PDCCH repetition transmission may improve coverage performance of the network.

The apparatus for processing PDCCH repetition transmission in this embodiment of this application may be an electronic device, for example, an electronic device with an operating system, or may be a component in the electronic device, for example, an integrated circuit or a chip. The electronic device may be a terminal or a network side device.

The apparatus for processing PDCCH repetition transmission provided in this embodiment of this application can implement the processes implemented in the method embodiment of FIG. 3, and achieve a same technical effect. To avoid repetition, details are not described herein again.

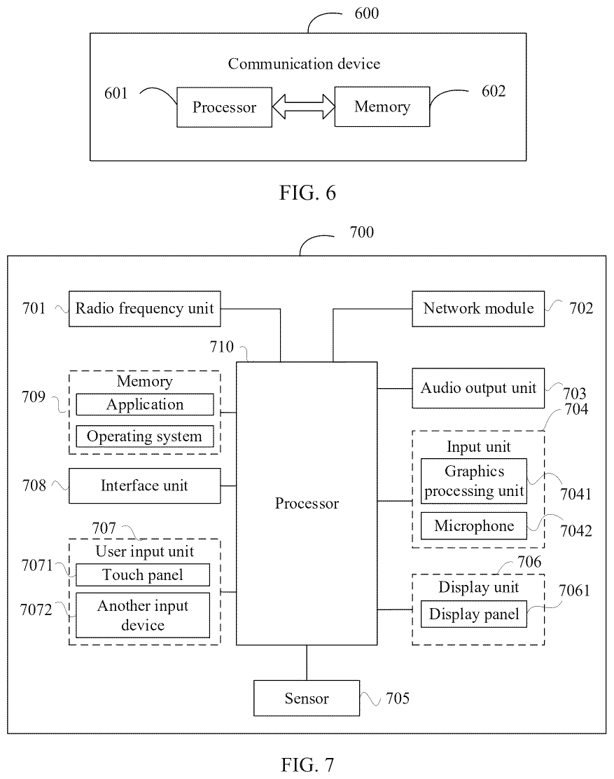

Optionally, as shown in FIG. 6, an embodiment of this application further provides a communication device 600, including a processor 601 and a memory 602. The memory 602 stores a program or an instruction that can be run on the processor 601. For example, when the communication device 600 is a terminal, the program or the instruction is executed by the processor 601 to implement the steps of the embodiment of the method for processing PDCCH repetition transmission on a terminal side, and a same technical effect can be achieved. When the communication device 600 is a network side device, the program or the instruction is executed by the processor 601 to implement the steps of the embodiment of the method for processing PDCCH repetition transmission on a network side, and a same technical effect can be achieved. To avoid repetition, details are not described herein again.

An embodiment of this application further provides a terminal, including a processor and a communication interface, where the communication interface is configured to obtain configuration information of common PDCCH repetition transmission; and an execution module is configured to receive the common PDCCH repetition transmission based on the configuration information. The common PDCCH includes at least one of the following: a system information block (SIB) 1 PDCCH, an OSI PDCCH, a message 2 PDCCH, a message 4 PDCCH, a message B PDCCH, a paging PDCCH, and a PDCCH for scheduling message 3 retransmission.

As shown in FIG. 7, the terminal 700 includes but is not limited to at least some components in: a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The structure of the communication device shown in FIG. 7 does not constitute a limitation on the communication device. The communication device may include components more or fewer than those shown in the diagram, a combination of some components, or different component arrangements. Details are not described herein.

It should be understood that in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, or the like. The modem processor mainly processes a wireless communication signal, for example, a baseband processor. It may be understood that, alternatively, the modem processor may not be integrated into the processor 710.

The radio frequency unit 701 is configured to: obtain configuration information of common PDCCH repetition transmission; and receive the common PDCCH repetition transmission based on the configuration information, where
the common PDCCH includes at least one of the following:
a system information block (SIB) 1 PDCCH, an OSI PDCCH, a message 2 PDCCH, a message 4 PDCCH, a message B PDCCH, a paging PDCCH, and a PDCCH for scheduling message 3 retransmission.

Optionally, the configuration information includes at least one of the following parameters:
a function of the common PDCCH repetition transmission;
a number of repetitions of the common PDCCH repetition transmission;
an index of the common PDCCH repetition transmission;
resource information of the common PDCCH repetition transmission;
activation information of the common PDCCH repetition transmission, the activation information representing activation or deactivation of the common PDCCH repetition transmission; and
a repetition mode of the common PDCCH repetition transmission.

Optionally, the resource information of the common PDCCH repetition transmission includes at least one of the following:
a pattern of the common PDCCH repetition transmission, the pattern indicating a resource location occupied by the common PDCCH repetition transmission;
indication information for indicating that the common PDCCH repetition transmission is performed based on an available slot; and
indication information for indicating that the common PDCCH repetition transmission is performed based on a physical slot.

Optionally, the repetition mode of the common PDCCH repetition transmission includes at least one of the following:
intra-slot repetition transmission; and
inter-slot repetition transmission.

Optionally, the obtaining configuration information of common PDCCH repetition transmission includes:
determining the configuration information of the common PDCCH repetition transmission based on indication information, the indication information including at least one of the following:
a synchronization signal block (SSB), a master information block (MIB), a physical broadcast channel (PBCH), a system information block (SIB), a radio network temporary identifier (RNTI), a control resource set (CORESET) configuration table, a monitoring occasion table of a common search space (CSS), a downlink channel receiving window, a downlink channel transmission period, a CORESET resource, a search space, a physical downlink control channel (PDCCH) monitoring occasion (MO), a physical random access channel (PRACH) resource, an SIB1 PDCCH, a message 2, a message B, a message 2 PDCCH, a message B PDCCH, a PDCCH for scheduling message 3 retransmission, radio resource control (RRC) signaling, a medium access control control element (MAC CE), a random access response, downlink control information (DCI), and a message 3.

Optionally, the indication information includes the PBCH, and the determining the configuration information of the common PDCCH repetition transmission based on indication information includes:
determining at least some parameters in the configuration information of the common PDCCH repetition transmission based on at least one of a demodulation reference signal (DMRS) sequence of the PBCH, a DMRS pattern of the PBCH, a DMRS time domain resource of the PBCH, a DMRS frequency domain resource of the PBCH, a scrambling sequence of the PBCH, and a payload of the PBCH.

Optionally, the RNTI includes a first RNTI defined for the common PDCCH repetition transmission, and the first RNTI is used for scrambling downlink control information (DCI) related to the common PDCCH, where
a generation manner of the first RNTI includes at least one of the following:
being generated based on a random access radio network temporary identifier (RA-RNTI) and an offset;
being generated based on a system information radio network temporary identifier (SI-RNTI) and an offset;
being generated based on a temporary cell radio network temporary identifier (TC-RNTI) and an offset;
being generated based on a paging radio network temporary identifier (P-RNTI) and an offset; and
being generated based on a message B radio network temporary identifier (MsgB-RNTI) and an offset, where
the offset is associated with the configuration information of the common PDCCH repetition transmission.

Optionally, the CORESET configuration table includes a first CORESET configuration table, the first CORESET configuration table is a CORESET resource configuration table for a type0-PDCCH search space set, and different resource configurations in the first CORESET configuration table correspond to respective configuration parameters of common PDCCH repetition transmission; or the CORESET configuration table includes a second CORESET configuration table, the second CORESET configuration table is a CORESET resource configuration table defined for the common PDCCH repetition transmission, and different indexes in the second CORESET configuration table correspond to respective configuration parameters of common PDCCH repetition transmission, where the configuration parameters of the common PDCCH repetition transmission are at least some parameters included in the configuration information of the common PDCCH repetition transmission;

or
the monitoring occasion table of the CSS includes a monitoring occasion table of a first CSS, the monitoring occasion table of the first CSS is a PDCCH monitoring occasion table for a type0-PDCCH search space set, and parameters of different PDCCH monitoring occasions in the monitoring occasion table of the first CSS correspond to respective configuration parameters of common PDCCH repetition transmission; or the monitoring occasion table of the CSS includes a monitoring occasion table of a second CSS, the monitoring occasion table of the second CSS is a CSS monitoring occasion table defined for the common PDCCH repetition transmission, and different indexes in the monitoring occasion table of the second CSS correspond to respective configuration parameters of common PDCCH repetition transmission, where the configuration parameters of the common PDCCH repetition transmission are at least some parameters included in the configuration information of the common PDCCH repetition transmission.

Optionally, a number of resources existing in the downlink channel receiving window is associated with some or all parameters in the configuration information, and the number of resources includes at least one of the following: a number of CORESETs, a number of search spaces, and a number of PDCCH MOs;
or
a transmission resource of the common PDCCH repetition transmission is located in the downlink channel receiving window;
or
a number of resources existing within the downlink channel transmission period is associated with some or all parameters in the configuration information, and the number of resources includes at least one of the following: a number of CORESETs, a number of search spaces, and a number of PDCCH MOs;
or
a transmission resource of the common PDCCH repetition transmission is located within the downlink channel transmission period.

Optionally, the downlink channel receiving window includes at least one of the following:
a window configured for the common PDCCH repetition transmission, a receiving window of a downlink channel defined in a protocol, and a window determined based on a downlink channel transmission parameter;
or
a downlink channel receiving period includes at least one of the following:
a period configured for the common PDCCH repetition transmission, a receiving period of a downlink channel defined in a protocol, and a period determined based on a downlink channel transmission parameter.

Optionally, the common PDCCH repetition transmission satisfies at least one of the following:
a time domain resource of the common PDCCH repetition transmission in CORESET #0 does not overlap with a time domain resource of an associated synchronization signal block (SSB); or a time domain resource of the common PDCCH repetition transmission in CORESET #0 overlaps with a time domain resource of an associated SSB;
the common PDCCH repetition transmission has a same number of transmissions within a plurality of SSB periods;
the common PDCCH repetition transmission has a same number of transmissions within a plurality of first periods, and the first period is a period within which an SSB is associated with an RO;
the common PDCCH repetition transmission is located in the downlink channel receiving window; and
the common PDCCH repetition transmission is located within the downlink channel transmission period.

Optionally, the common PDCCH repetition transmission includes repetition transmission in time domain, and repetition transmission of the common PDCCH in time domain includes at least one of the following:
repetition transmission of the common PDCCH on different PDCCH MOs in a same search space of a same CORESET;
repetition transmission of the common PDCCH in different search spaces of a same CORESET;
repetition transmission of the common PDCCH in different search spaces of different CORESETs; and
repetition transmission of the common PDCCH in a same search space of different CORESETs;
or
the common PDCCH repetition transmission includes repetition transmission in frequency domain, and repetition transmission of the common PDCCH in frequency domain includes at least one of the following:
repetition transmission of the common PDCCH on a same PDCCH MO of a same CORESET; and
repetition transmission of the common PDCCH on a same PDCCH MO of different CORESETs.

Optionally, the processor 710 is configured to drop reception of repetition transmission of the common PDCCH in a case that a resource for repetition transmission of the common PDCCH conflicts with a resource for a first transmission of another common PDCCH.

Optionally, the receiving the common PDCCH repetition transmission based on the configuration information includes:
receiving the PDCCH repetition transmission based on the configuration information of the PDCCH repetition transmission and timeline information of the common PDCCH repetition transmission, the timeline information of the common PDCCH repetition transmission including at least one of the following:
a time sequence relationship between the common PDCCH repetition transmission and a physical downlink shared channel (PDSCH) scheduled by a common PDCCH;
a time relationship between the common PDCCH repetition transmission and an RAR receiving window;
a time relationship between the common PDCCH repetition transmission and a contention resolution timer; and
a time relationship between the common PDCCH repetition transmission and a message B-response window.

Optionally, the time sequence relationship between the common PDCCH repetition transmission and the PDSCH scheduled by the common PDCCH includes one of the following:
a slot offset of the PDSCH scheduled by the common PDCCH is an offset relative to a slot in which a first transmission of the common PDCCH repetition transmission is located;
a slot offset of the PDSCH scheduled by the common PDCCH is a slot offset relative to a slot in which a last transmission of the common PDCCH repetition transmission is located;
a slot offset of the PDSCH scheduled by the common PDCCH is a slot offset relative to a slot in which an n^{th} transmission of the common PDCCH repetition transmission is located, and a value of n is configured by a network side or specified in a protocol; and
a slot offset of the PDSCH scheduled by the common PDCCH is an offset relative to a target time point of a receiving window associated with the common PDCCH repetition transmission.

Optionally, the first transmission of the common PDCCH includes one of the following:
a first transmission of the common PDCCH repetition transmission in a physical slot;
a first transmission of the common PDCCH repetition transmission in an available slot;
a first transmission of the common PDCCH repetition transmission in the RAR receiving window;
a first transmission of the common PDCCH repetition transmission in the message B-response window; and
a first valid transmission of the common PDCCH repetition transmission;
or
the last transmission of the common PDCCH repetition transmission includes one of the following:
a last transmission of the common PDCCH repetition transmission in a physical slot;
a last transmission of the common PDCCH repetition transmission in an available slot;
a last transmission of the common PDCCH repetition transmission in the RAR receiving window;
a last transmission of the common PDCCH repetition transmission in the message B-response window; and
a last valid transmission of the common PDCCH repetition transmission;
or
the n^{th} transmission of the common PDCCH repetition transmission includes one of the following:
an n^{th} transmission of the common PDCCH repetition transmission in a physical slot;
an n^{th} transmission of the common PDCCH repetition transmission in an available slot;
an n^{th} transmission of the common PDCCH repetition transmission in the RAR
an n^{th} transmission of the common PDCCH repetition transmission in the message B-response window; and
an n^{th} valid transmission of the common PDCCH repetition transmission.

Optionally, the time relationship between the common PDCCH repetition transmission and the RAR receiving window includes one of the following:
the common PDCCH repetition transmission is allowed to cross the RAR receiving window, and the common PDCCH repetition transmission is not allowed to cross the RAR receiving window;
or
the time relationship between the common PDCCH repetition transmission and a contention resolution timer includes one of the following:
the common PDCCH repetition transmission is allowed to cross the contention resolution timer, and the common PDCCH repetition transmission is not allowed to cross the contention resolution timer;
or
the time relationship between the common PDCCH repetition transmission and a message B-response window includes one of the following:
the common PDCCH repetition transmission is allowed to cross the message B-response window, and the common PDCCH repetition transmission is not allowed to cross the message B-response window.

Optionally, the RAR receiving window includes: an RAR receiving window available for the common PDCCH repetition transmission; or an RAR receiving window that is obtained after an offset is added to an RAR receiving window not available for the common PDCCH repetition transmission;
or
the message B-response window includes:
a message B-response window available for the common PDCCH repetition transmission; or a message B-response window that is obtained after an offset is added to a message B-response window not available for the common PDCCH repetition transmission;
or
the contention resolution timer includes:
a defined contention resolution timer available for the common PDCCH repetition transmission; or a contention resolution timer that is obtained after an offset is added to a contention resolution timer not available for the common PDCCH repetition transmission.

Optionally, a starting moment of the RAR receiving window includes:
a 1^{st} symbol of a CORESET that meets a target condition earliest in a first resource, where
the first resource includes:
a resource that is located after a last symbol occupied by a PRACH and that is separated from the last symbol occupied by the PRACH by at least one symbol; or
a resource that is located after a last symbol occupied by a PRACH and that is separated from the last symbol occupied by the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

Optionally, a starting moment of the contention resolution timer includes a first moment after an end of transmission of the message 3, or an interval between a starting moment of the contention resolution timer and a transmission end moment of the message 3 is equal to or greater than a round trip time (RTT), where
the first moment includes at least one of the following:
a 1^{st} symbol of a next slot after the end of transmission of the message 3;
a 1^{st} symbol of an earliest CORESET after the end of transmission of the message 3; and
a 1^{st} symbol of a CORESET that meets a target condition earliest in a second resource, where
the second resource includes:
a resource that is separated from the end of transmission of the message 3 by at least one symbol after the end of transmission of the message 3.

Optionally, a starting moment of the message B-response window includes at least one of the following:
a 1^{st} symbol of a CORESET in which the first transmission of the common PDCCH repetition transmission is located;
a 1^{st} symbol of a CORESET in which the last transmission of the common PDCCH repetition transmission is located;
a 1^{st} symbol of a CORESET in which an i^{th} transmission of the common PDCCH repetition transmission is located, a value of i being equal to or greater than 1 and less than or equal to a number of repetitions of the common PDCCH;
a 1^{st} symbol of an earliest CORESET in a third resource; and
a 1^{st} symbol of a CORESET that meets a target condition earliest in a third resource, where
the third resource includes:
a resource that is located after a last symbol of a physical uplink shared channel (PUSCH) occasion corresponding to a PRACH and that is separated from the last symbol of the PUSCH occasion corresponding to the PRACH by at least one symbol; or
a resource that is located after a last symbol of a PUSCH occasion corresponding to a PRACH and that is separated from the last symbol of the PUSCH occasion corresponding to the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

Optionally, the CORESET that meets a target condition includes:
a CORESET in which an i^{th} transmission of the common PDCCH repetition transmission is located, a value of i being equal to or greater than 1 and less than or equal to the number of repetitions of the common PDCCH.

Optionally, the processor 710 is configured to deactivate the common PDCCH repetition transmission when any one of the following is met:
the terminal sends the message 3;
the terminal receives a success RAR;
the RAR receiving window ends;
a maximum allowed RAR window ends;
the contention resolution timer expires;
a message 4 is decoded successfully;
the message B is decoded successfully; and
a network side configuration performs deactivation.

Optionally, in a case that the i^{th} transmission of the common PDCCH repetition transmission and the PDSCH scheduled by the common PDCCH are in a same slot, a relationship between a starting symbol of the PDSCH scheduled by the common PDCCH and the common PDCCH repetition transmission includes at least one of the following:
the starting symbol of the PDSCH scheduled by the common PDCCH is separated from a starting symbol of the i^{th} transmission of the common PDCCH repetition transmission by N symbols; and
the starting symbol of the PDSCH scheduled by the common PDCCH is separated from a symbol of the i^{th} transmission of the common PDCCH repetition transmission by N symbols, where
the value of i is equal to or greater than 1, and less than or equal to the number of repetitions of the common PDCCH, and N is greater than or equal to 0.

The terminal may improve coverage performance of the network.

It can be understood that for the implementation process of each implementation given in this embodiment, refer to the related description of the method embodiment, and a same or corresponding technical effect is achieved. To avoid repetition, details are not described herein again.

An embodiment of this application further provides a network side device, including a processor and a communication interface. The communication interface or the processor is configured to send indication information to a terminal or determine time relationship information of common PDCCH repetition transmission, where the indication information is used for indicating the configuration information of the common PDCCH repetition transmission.

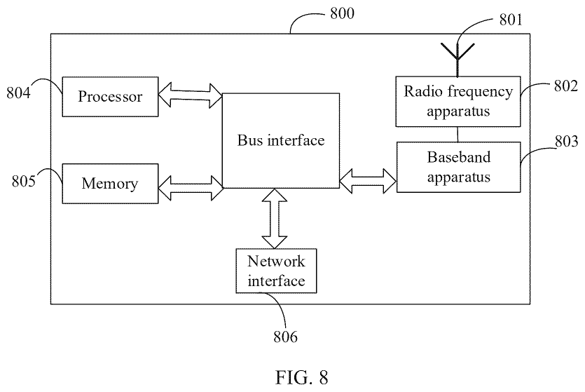

As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the radio access network device may be implemented in a baseband apparatus 803. The baseband apparatus 803 includes a baseband processor.

For example, the baseband apparatus 803 may include at least one baseband board. A plurality of chips are disposed on the baseband board. As shown in FIG. 8, one chip is, for example, a baseband processor, and is connected to the memory 805 by using a bus interface, to invoke a program in the memory 805 to perform the operations of the network device shown in the foregoing method embodiment.

The radio access network device may further include a network interface 806, and the interface is, for example, a common public radio interface (CPRI).

Specifically, the network side device 800 in this embodiment of this application further includes an instruction or a program that is stored in the memory 805 and that can be run on the processor 804. The processor 804 invokes the instruction or the program in the memory 805 to perform the method performed by the modules shown in FIG. 5, and a same technical effect is achieved. To avoid repetition, details are not described herein again.

The radio frequency apparatus 802 is configured to send configuration information of common PDCCH repetition transmission to a terminal; and
an execution module is configured to perform the common PDCCH repetition transmission based on the configuration information, where
the common PDCCH includes at least one of the following:
an SIB1 PDCCH, an OSI PDCCH, a message 2 PDCCH, a message 4 PDCCH, a message B PDCCH, a paging PDCCH, and a PDCCH for scheduling message 3 retransmission.

Optionally, the configuration information includes at least one of the following parameters:
a function of the common PDCCH repetition transmission;
a number of repetitions of the common PDCCH repetition transmission;
an index of the common PDCCH repetition transmission;
resource information of the common PDCCH repetition transmission;
activation information of the common PDCCH repetition transmission, the activation information representing activation or deactivation of the common PDCCH repetition transmission; and
a repetition mode of the common PDCCH repetition transmission.

Optionally, the resource information of the common PDCCH repetition transmission includes at least one of the following:
a pattern of the common PDCCH repetition transmission, the pattern indicating a resource location occupied by the common PDCCH repetition transmission;
indication information for indicating that the common PDCCH repetition transmission is performed based on an available slot; and
indication information for indicating that the common PDCCH repetition transmission is performed based on a physical slot.

Optionally, the repetition mode of the common PDCCH repetition transmission includes at least one of the following:
intra-slot repetition transmission; and
inter-slot repetition transmission.

Optionally, the sending configuration information of common PDCCH repetition transmission to a terminal includes:
sending indication information to the terminal, the indication information being used for determining the configuration information of the common PDCCH repetition transmission, and the indication information including at least one of the following:
a synchronization signal block (SSB), a master information block (MIB), a physical broadcast channel (PBCH), a system information block (SIB), a radio network temporary identifier (RNTI), a control resource set (CORESET) configuration table, a monitoring occasion table of a common search space (CSS), a downlink channel receiving window, a downlink channel transmission period, a CORESET resource, a search space, a physical downlink control channel (PDCCH) monitoring occasion (MO), a physical random access channel (PRACH) resource, an SIB1 PDCCH, a message 2, a message B, a message 2 PDCCH, a message B PDCCH, a PDCCH for scheduling message 3 retransmission, radio resource control (RRC) signaling, a medium access control control element (MAC CE), a random access response, downlink control information (DCI), and a message 3.

Optionally, at least one of the following items in the PBCH is used for indicating some or all of the configuration information:
a demodulation reference signal (DMRS) of the PBCH, a scrambling sequence of the PBCH, and a payload of the PBCH, where
the DMRS includes at least one of the following: a DMRS sequence, a DMRS pattern, a DMRS time domain resource, and a DMRS frequency domain resource.

Optionally, the RNTI includes a first RNTI defined for the common PDCCH repetition transmission, and the first RNTI is used for scrambling downlink control information (DCI) related to the common PDCCH, where
a generation manner of the first RNTI includes at least one of the following:
being generated based on a random access radio network temporary identifier (RA-RNTI) and an offset;
being generated based on a system information radio network temporary identifier (SI-RNTI) and an offset;
being generated based on a temporary cell radio network temporary identifier (TC-RNTI) and an offset;
being generated based on a paging radio network temporary identifier (P-RNTI) and an offset; and
being generated based on a message B radio network temporary identifier (MsgB-RNTI) and an offset, where
the offset is associated with the configuration information of the common PDCCH repetition transmission.

Optionally, the CORESET configuration table includes a first CORESET configuration table, the first CORESET configuration table is a CORESET resource configuration table for a type0-PDCCH search space set, and different resource configurations in the first CORESET configuration table correspond to respective configuration parameters of common PDCCH repetition transmission; or the CORESET configuration table includes a second CORESET configuration table, the second CORESET configuration table is a CORESET resource configuration table defined for the common PDCCH repetition transmission, and different indexes in the second CORESET configuration table correspond to respective configuration parameters of common PDCCH repetition transmission, where the configuration parameters of the common PDCCH repetition transmission are at least some parameters included in the configuration information of the common PDCCH repetition transmission;
or
the monitoring occasion table of the CSS includes a monitoring occasion table of a first CSS, the monitoring occasion table of the first CSS is a PDCCH monitoring occasion table for a type0-PDCCH search space set, and parameters of different PDCCH monitoring occasions in the monitoring occasion table of the first CSS correspond to respective configuration parameters of common PDCCH repetition transmission; or the monitoring occasion table of the CSS includes a monitoring occasion table of a second CSS, the monitoring occasion table of the second CSS is a CSS monitoring occasion table defined for the common PDCCH repetition transmission, and different indexes in the monitoring occasion table of the second CSS correspond to respective configuration parameters of common PDCCH repetition transmission, where the configuration parameters of the common PDCCH repetition transmission are at least some parameters included in the configuration information of the common PDCCH repetition transmission.

Optionally, a number of resources existing in the downlink channel receiving window is associated with some or all parameters in the configuration information, and the number of resources includes at least one of the following: a number of CORESETs, a number of search spaces, and a number of PDCCH MOs;
or
a transmission resource of the common PDCCH repetition transmission is located in the downlink channel receiving window;
or
a number of resources existing within the downlink channel transmission period is associated with some or all parameters in the configuration information, and the number of resources includes at least one of the following: a number of CORESETs, a number of search spaces, and a number of PDCCH MOs;
or
a transmission resource of the common PDCCH repetition transmission is located within the downlink channel transmission period.

Optionally, the downlink channel receiving window includes at least one of the following:
a window configured for the common PDCCH repetition transmission, a receiving window of a downlink channel defined in a protocol, and a window determined based on a downlink channel transmission parameter;
or
a downlink channel receiving period includes at least one of the following:
a period configured for the common PDCCH repetition transmission, a receiving period of a downlink channel defined in a protocol, and a period determined based on a downlink channel transmission parameter.

Optionally, the common PDCCH repetition transmission satisfies at least one of the following:
a time domain resource of the common PDCCH repetition transmission in CORESET #0 does not overlap with a time domain resource of an associated synchronization signal block (SSB); or a time domain resource of the common PDCCH repetition transmission in CORESET #0 overlaps with a time domain resource of an associated SSB;
the common PDCCH repetition transmission has a same number of transmissions within a plurality of SSB periods;
the common PDCCH repetition transmission has a same number of transmissions within a plurality of first periods, and the first period is a period within which an SSB is associated with an RO;
the common PDCCH repetition transmission is located in the downlink channel receiving window; and
the common PDCCH repetition transmission is located within the downlink channel transmission period.

Optionally, the common PDCCH repetition transmission includes repetition transmission in time domain, and repetition transmission of the common PDCCH in time domain includes at least one of the following:
repetition transmission of the common PDCCH on different PDCCH MOs in a same search space of a same CORESET;
repetition transmission of the common PDCCH in different search spaces of a same CORESET;
repetition transmission of the common PDCCH in different search spaces of different CORESETs; and
repetition transmission of the common PDCCH in a same search space of different CORESETs;
or
the common PDCCH repetition transmission includes repetition transmission in frequency domain, and repetition transmission of the common PDCCH in frequency domain includes at least one of the following:
repetition transmission of the common PDCCH on a same PDCCH MO of a same CORESET; and
repetition transmission of the common PDCCH on a same PDCCH MO of different CORESETs.

Optionally, the processor 804 is configured to drop repetition transmission of the common PDCCH in a case that a resource for repetition transmission of the common PDCCH conflicts with a resource for a first transmission of another common PDCCH.

Optionally, the performing the common PDCCH repetition transmission based on the configuration information includes:
performing the PDCCH repetition transmission based on the configuration information of the PDCCH repetition transmission and timeline information of the common PDCCH repetition transmission, the timeline information of the common PDCCH repetition transmission including at least one of the following:
a time sequence relationship between the common PDCCH repetition transmission and a physical downlink shared channel (PDSCH) scheduled by a common PDCCH;
a time relationship between the common PDCCH repetition transmission and an RAR receiving window;
a time relationship between the common PDCCH repetition transmission and a contention resolution timer; and
a time relationship between the common PDCCH repetition transmission and a message B-response window.

Optionally, the time sequence relationship between the common PDCCH repetition transmission and the PDSCH scheduled by the common PDCCH includes one of the following:
a slot offset of the PDSCH scheduled by the common PDCCH is an offset relative to a slot in which a first transmission of the common PDCCH repetition transmission is located;
a slot offset of the PDSCH scheduled by the common PDCCH is a slot offset relative to a slot in which a last transmission of the common PDCCH repetition transmission is located;
a slot offset of the PDSCH scheduled by the common PDCCH is a slot offset relative to a slot in which an n^{th} transmission of the common PDCCH repetition transmission is located, and a value of n is configured by a network side or specified in a protocol; and
a slot offset of the PDSCH scheduled by the common PDCCH is an offset relative to a target time point of a receiving window associated with the common PDCCH repetition transmission.

Optionally, the first transmission of the common PDCCH includes one of the following:
a first transmission of the common PDCCH repetition transmission in a physical slot;
a first transmission of the common PDCCH repetition transmission in an available slot;
a first transmission of the common PDCCH repetition transmission in the RAR receiving window;
a first transmission of the common PDCCH repetition transmission in the message B-response window; and
a first valid transmission of the common PDCCH repetition transmission;
or
the last transmission of the common PDCCH repetition transmission includes one of the following:
a last transmission of the common PDCCH repetition transmission in a physical slot;
a last transmission of the common PDCCH repetition transmission in an available slot;
a last transmission of the common PDCCH repetition transmission in the RAR receiving window;
a last transmission of the common PDCCH repetition transmission in the message B-response window; and
a last valid transmission of the common PDCCH repetition transmission;
or
the n^{th} transmission of the common PDCCH repetition transmission includes one of the following:
an n^{th} transmission of the common PDCCH repetition transmission in a physical slot;
an n^{th} transmission of the common PDCCH repetition transmission in an available slot;
an n^{th} transmission of the common PDCCH repetition transmission in the RAR receiving window;
an n^{th} transmission of the common PDCCH repetition transmission in the message B-response window; and
an n^{th} valid transmission of the common PDCCH repetition transmission.

Optionally, the time relationship between the common PDCCH repetition transmission and the RAR receiving window includes one of the following:
the common PDCCH repetition transmission is allowed to cross the RAR receiving window, and the common PDCCH repetition transmission is not allowed to cross the RAR receiving window;
or
the time relationship between the common PDCCH repetition transmission and a contention resolution timer includes one of the following:
the common PDCCH repetition transmission is allowed to cross the contention resolution timer, and the common PDCCH repetition transmission is not allowed to cross the contention resolution timer;
or
the time relationship between the common PDCCH repetition transmission and a message B-response window includes one of the following:
the common PDCCH repetition transmission is allowed to cross the message B-response window, and the common PDCCH repetition transmission is not allowed to cross the message B-response window.

Optionally, the RAR receiving window includes: an RAR receiving window available for the common PDCCH repetition transmission; or an RAR receiving window that is obtained after an offset is added to an RAR receiving window not available for the common PDCCH repetition transmission;
or
the message B-response window includes:
a message B-response window available for the common PDCCH repetition transmission; or a message B-response window that is obtained after an offset is added to a message B-response window not available for the common PDCCH repetition transmission;
or
the contention resolution timer includes:
a defined contention resolution timer available for the common PDCCH repetition transmission; or a contention resolution timer that is obtained after an offset is added to a contention resolution timer not available for the common PDCCH repetition transmission.

Optionally, a starting moment of the RAR receiving window includes:
a 1^{st} symbol of a CORESET that meets a target condition earliest in a first resource, where
the first resource includes:
a resource that is located after a last symbol occupied by a PRACH and that is separated from the last symbol occupied by the PRACH by at least one symbol; or
a resource that is located after a last symbol occupied by a PRACH and that is separated from the last symbol occupied by the PRACH by an interval greater than or equal to
a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

Optionally, a starting moment of the contention resolution timer includes a first moment after an end of transmission of the message 3, or an interval between a starting moment of the contention resolution timer and a transmission end moment of the message 3 is equal to or greater than a round trip time (RTT), where
the first moment includes at least one of the following:
a 1^{st} symbol of a next slot after the end of transmission of the message 3;
a 1^{st} symbol of an earliest CORESET after the end of transmission of the message 3; and
a 1^{st} symbol of a CORESET that meets a target condition earliest in a second resource, where
the second resource includes:
a resource that is separated from the end of transmission of the message 3 by at least one symbol after the end of transmission of the message 3.

Optionally, a starting moment of the message B-response window includes at least one of the following:
a 1^{st} symbol of a CORESET in which the first transmission of the common PDCCH repetition transmission is located;
a 1^{st} symbol of a CORESET in which the last transmission of the common PDCCH repetition transmission is located;
a 1^{st} symbol of a CORESET in which an i^{th} transmission of the common PDCCH repetition transmission is located, a value of i being equal to or greater than 1 and less than or equal to a number of repetitions of the common PDCCH;
a 1^{st} symbol of an earliest CORESET in a third resource; and
a 1^{st} symbol of a CORESET that meets a target condition earliest in a third resource, where
the third resource includes:
a resource that is located after a last symbol of a physical uplink shared channel (PUSCH) occasion corresponding to a PRACH and that is separated from the last symbol of the PUSCH occasion corresponding to the PRACH by at least one symbol; or
a resource that is located after a last symbol of a PUSCH occasion corresponding to a PRACH and that is separated from the last symbol of the PUSCH occasion corresponding to the PRACH by an interval greater than or equal to a target time, the target time being equal to at least one symbol +T_{TA}+k_{mac}, T_{TA} indicating duration of timing advance, and k_{mac} indicating a scheduling offset supported by a non-terrestrial network (NTN) for enhancement of a timing relationship of a medium access control control element (MAC CE).

Optionally, the CORESET that meets a target condition includes:
a CORESET in which an i^{th} transmission of the common PDCCH repetition transmission is located, a value of i being equal to or greater than 1 and less than or equal to the number of repetitions of the common PDCCH.

Optionally, the processor 804 is configured to deactivate the common PDCCH repetition transmission when any one of the following is met:
the terminal sends the message 3;
the terminal receives a success RAR;
the RAR receiving window ends;
a maximum allowed RAR window ends;
the contention resolution timer expires;
a message 4 is decoded successfully;
the message B is decoded successfully; and
a network side configuration performs deactivation.

Optionally, in a case that the i^{th} transmission of the common PDCCH repetition transmission and the PDSCH scheduled by the common PDCCH are in a same slot, a relationship between a starting symbol of the PDSCH scheduled by the common PDCCH and the common PDCCH repetition transmission includes at least one of the following:
the starting symbol of the PDSCH scheduled by the common PDCCH is separated from a starting symbol of the i^{th} transmission of the common PDCCH repetition transmission by N symbols; and
the starting symbol of the PDSCH scheduled by the common PDCCH is separated from a symbol of the i^{th} transmission of the common PDCCH repetition transmission by N symbols, where
the value of i is equal to or greater than 1, and less than or equal to the number of repetitions of the common PDCCH, and N is greater than or equal to 0.

The network side device may improve coverage performance of the network.

An embodiment of this application further provides a readable storage medium. The readable storage medium stores a program or an instruction, and when the program or the instruction is executed by a processor, the processes of the embodiment of the method for processing PDCCH repetition transmission are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, and the communication interface is coupled to the processor. The processor is configured to run a program or an instruction, to implement the processes of the embodiment of the method for processing PDCCH repetition transmission, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes of the embodiment of the method for processing PDCCH repetition transmission, and a same technical effect can be achieved. To avoid repetition, details are not described herein again.

An embodiment of this application further provides a wireless communication system, including a terminal and a network side device. The terminal may be configured to perform the steps of the method for processing PDCCH repetition transmission on a terminal side provided in an embodiment of this application, and the network side device may be configured to perform the steps of the method for processing PDCCH repetition transmission on a network side provided in an embodiment of this application.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product and a required universal hardware platform, or certainly may be implemented by using hardware. The computer software product is stored in a storage medium (for example, a ROM, a RAM, a magnetic disk, or an optical disc), and includes a plurality of instructions for instructing a terminal or a network side device to perform the method described in the embodiments of this application.

The embodiments of this application are described above with reference to the accompanying drawings, but this application is not limited to the above specific implementations, and the above specific implementations are only illustrative and not restrictive.

1. A method for processing physical downlink control channel (PDCCH) repetition transmission, comprising:
obtaining, by a terminal, configuration information of common PDCCH repetition transmission; and
receiving, by the terminal, the common PDCCH repetition transmission based on the configuration information, wherein
the common PDCCH comprises at least one of the following:
a system information block (SIB) 1 PDCCH, an other system information (OSI) PDCCH, a message 2 PDCCH, a message 4 PDCCH, a message B PDCCH, a paging PDCCH, or a PDCCH for scheduling message 3 retransmission.

2. The method according to claim 1, wherein the configuration information comprises at least one of the following parameters:
a function of the common PDCCH repetition transmission;
a number of repetitions of the common PDCCH repetition transmission;
an index of the common PDCCH repetition transmission;
resource information of the common PDCCH repetition transmission;
activation information of the common PDCCH repetition transmission, the activation information representing activation or deactivation of the common PDCCH repetition transmission; or
a repetition mode of the common PDCCH repetition transmission.

3. The method according to claim 2, wherein the resource information of the common PDCCH repetition transmission comprises at least one of the following:
a pattern of the common PDCCH repetition transmission, the pattern indicating a resource location occupied by the common PDCCH repetition transmission;
indication information for indicating that the common PDCCH repetition transmission is performed based on an available slot; or
indication information for indicating that the common PDCCH repetition transmission is performed based on a physical slot.

4. The method according to claim 1, wherein the obtaining, by a terminal, configuration information of common PDCCH repetition transmission comprises:
determining, by the terminal, the configuration information of the common PDCCH repetition transmission based on indication information, the indication information comprising at least one of the following:
a synchronization signal block (SSB), a master information block (MIB), a physical broadcast channel (PBCH), a system information block (SIB), a radio network temporary identifier (RNTI), a control resource set (CORESET) configuration table, a monitoring occasion table of a common search space (CSS), a downlink channel receiving window, a downlink channel transmission period, a CORESET resource, a search space, a physical downlink control channel (PDCCH) monitoring occasion (MO), a physical random access channel (PRACH) resource, an SIB1 PDCCH, a message 2, a message B, a message 2 PDCCH, a message B PDCCH, a PDCCH for scheduling message 3 retransmission, radio resource control (RRC) signaling, a medium access control control element (MAC CE), a random access response, downlink control information (DCI), or a message 3.

5. The method according to claim 4, wherein the indication information comprises the PBCH, and the determining, by the terminal, the configuration information of the common PDCCH repetition transmission based on indication information comprises:
determining at least some parameters in the configuration information of the common PDCCH repetition transmission based on at least one of a demodulation reference signal (DMRS) sequence of the PBCH, a DMRS pattern of the PBCH, a DMRS time domain resource of the PBCH, a DMRS frequency domain resource of the PBCH, a scrambling sequence of the PBCH, or a payload of the PBCH.

6. The method according to claim 4, wherein the RNTI comprises a first RNTI defined for the common PDCCH repetition transmission, and the first RNTI is used for scrambling downlink control information (DCI) related to the common PDCCH; and
a generation manner of the first RNTI comprises at least one of the following:
being generated based on a random access radio network temporary identifier (RA-RNTI) and an offset;
being generated based on a system information radio network temporary identifier (SI-RNTI) and an offset;
being generated based on a temporary cell radio network temporary identifier (TC-RNTI) and an offset;
being generated based on a paging radio network temporary identifier (P-RNTI) and an offset; or
being generated based on a message B radio network temporary identifier (MsgB-RNTI) and an offset, wherein
the offset is associated with the configuration information of the common PDCCH repetition transmission.

7. The method according to claim 4, wherein the CORESET configuration table comprises a first CORESET configuration table, the first CORESET configuration table is a CORESET resource configuration table for a type0-PDCCH search space set, and different resource configurations in the first CORESET configuration table correspond to respective configuration parameters of common PDCCH repetition transmission; or the CORESET configuration table comprises a second CORESET configuration table, the second CORESET configuration table is a CORESET resource configuration table defined for the common PDCCH repetition transmission, and different indexes in the second CORESET configuration table correspond to respective configuration parameters of common PDCCH repetition transmission, wherein the configuration parameters of the common PDCCH repetition transmission are at least some parameters comprised in the configuration information of the common PDCCH repetition transmission;
or
the monitoring occasion table of the CSS comprises a monitoring occasion table of a first CSS, the monitoring occasion table of the first CSS is a PDCCH monitoring occasion table for a type0-PDCCH search space set, and parameters of different PDCCH monitoring occasions in the monitoring occasion table of the first CSS correspond to respective configuration parameters of common PDCCH repetition transmission; or the monitoring occasion table of the CSS comprises a monitoring occasion table of a second CSS, the monitoring occasion table of the second CSS is a CSS monitoring occasion table defined for the common PDCCH repetition transmission, and different indexes in the monitoring occasion table of the second CSS correspond to respective configuration parameters of common PDCCH repetition transmission, wherein the configuration parameters of the common PDCCH repetition transmission are at least some parameters comprised in the configuration information of the common PDCCH repetition transmission.

8. The method according to claim 4, wherein a number of resources existing in the downlink channel receiving window is associated with some or all parameters in the configuration information, and the number of resources comprises at least one of the following: a number of CORESETs, a number of search spaces, or a number of PDCCH MOs;
or
a transmission resource of the common PDCCH repetition transmission is located in the downlink channel receiving window;
or
a number of resources existing within the downlink channel transmission period is associated with some or all parameters in the configuration information, and the number of resources comprises at least one of the following: a number of CORESETs, a number of search spaces, or a number of PDCCH MOs;
or
a transmission resource of the common PDCCH repetition transmission is located within the downlink channel transmission period.

9. The method according to claim 4, wherein the downlink channel receiving window comprises at least one of the following:
a window configured for the common PDCCH repetition transmission, a receiving window of a downlink channel defined in a protocol, or a window determined based on a downlink channel transmission parameter;
or
a downlink channel receiving period comprises at least one of the following:
a period configured for the common PDCCH repetition transmission, a receiving period of a downlink channel defined in a protocol, or a period determined based on a downlink channel transmission parameter.

10. The method according to claim 1, wherein the common PDCCH repetition transmission satisfies at least one of the following:
a time domain resource of the common PDCCH repetition transmission in CORESET #0 does not overlap with a time domain resource of an associated synchronization signal block (SSB); or a time domain resource of the common PDCCH repetition transmission in CORESET #0 overlaps with a time domain resource of an associated SSB;
the common PDCCH repetition transmission has a same number of transmissions within a plurality of SSB periods;
the common PDCCH repetition transmission has a same number of transmissions within a plurality of first periods, and the first period is a period within which an SSB is associated with a random access channel occasion (RO);
the common PDCCH repetition transmission is located in the downlink channel receiving window; or
the common PDCCH repetition transmission is located within the downlink channel transmission period;
or,
wherein the common PDCCH repetition transmission comprises repetition transmission in time domain, and repetition transmission of the common PDCCH in time domain comprises at least one of the following:
repetition transmission of the common PDCCH on different PDCCH MOs in a same search space of a same CORESET;
repetition transmission of the common PDCCH in different search spaces of a same CORESET;
repetition transmission of the common PDCCH in different search spaces of different CORESETs; or
repetition transmission of the common PDCCH in a same search space of different CORESETs;
or
the common PDCCH repetition transmission comprises repetition transmission in frequency domain, and repetition transmission of the common PDCCH in frequency domain comprises at least one of the following:
repetition transmission of the common PDCCH on a same PDCCH MO of a same CORESET; or
repetition transmission of the common PDCCH on a same PDCCH MO of different CORESETs.

11. The method according to claim 1, wherein the method further comprises:
dropping, by the terminal, reception of repetition transmission of the common PDCCH in a case that a resource for repetition transmission of the common PDCCH conflicts with a resource for a first transmission of another common PDCCH.

12. The method according to claim 1, wherein the receiving, by the terminal, the PDCCH repetition transmission based on the configuration information of the PDCCH repetition transmission comprises:
receiving, by the terminal, the PDCCH repetition transmission based on the configuration information of the PDCCH repetition transmission and timeline information of the common PDCCH repetition transmission, the timeline information of the common PDCCH repetition transmission comprising at least one of the following:
a time sequence relationship between the common PDCCH repetition transmission and a physical downlink shared channel (PDSCH) scheduled by a common PDCCH;
a time relationship between the common PDCCH repetition transmission and an RAR receiving window;
a time relationship between the common PDCCH repetition transmission and a contention resolution timer; or
a time relationship between the common PDCCH repetition transmission and a message B-response window.

13. The method according to claim 12, wherein the time sequence relationship between the common PDCCH repetition transmission and a PDSCH scheduled by a common PDCCH comprises one of the following:
a slot offset of the PDSCH scheduled by the common PDCCH is an offset relative to a slot in which a first transmission of the common PDCCH repetition transmission is located;
a slot offset of the PDSCH scheduled by the common PDCCH is a slot offset relative to a slot in which a last transmission of the common PDCCH repetition transmission is located;
a slot offset of the PDSCH scheduled by the common PDCCH is a slot offset relative to a slot in which an n^{th} transmission of the common PDCCH repetition transmission is located, and a value of n is configured by a network side or specified in a protocol; or
a slot offset of the PDSCH scheduled by the common PDCCH is an offset relative to a target time point of a receiving window associated with the common PDCCH repetition transmission;
wherein the first transmission of the common PDCCH comprises one of the following:
a first transmission of the common PDCCH repetition transmission in a physical slot;
a first transmission of the common PDCCH repetition transmission in an available slot;
a first transmission of the common PDCCH repetition transmission in the RAR receiving window;
a first transmission of the common PDCCH repetition transmission in the message B-response window; or
a first valid transmission of the common PDCCH repetition transmission;
or
the last transmission of the common PDCCH repetition transmission comprises one of the following:
a last transmission of the common PDCCH repetition transmission in a physical slot;
a last transmission of the common PDCCH repetition transmission in an available slot;
a last transmission of the common PDCCH repetition transmission in the RAR receiving window;
a last transmission of the common PDCCH repetition transmission in the message B-response window; or
a last valid transmission of the common PDCCH repetition transmission;
or
the n^{th} transmission of the common PDCCH repetition transmission comprises one of the following:
an n^{th} transmission of the common PDCCH repetition transmission in a physical slot;
an n^{th} transmission of the common PDCCH repetition transmission in an available slot;
an n^{th} transmission of the common PDCCH repetition transmission in the RAR receiving window;
an n^{th} transmission of the common PDCCH repetition transmission in the message B-response window; or
an n^{th} valid transmission of the common PDCCH repetition transmission.

14. The method according to claim 12, wherein the time relationship between the common PDCCH repetition transmission and an RAR receiving window comprises one of the following:
the common PDCCH repetition transmission is allowed to cross the RAR receiving window, or the common PDCCH repetition transmission is not allowed to cross the RAR receiving window;
or
the time relationship between the common PDCCH repetition transmission and a contention resolution timer comprises one of the following:
the common PDCCH repetition transmission is allowed to cross the contention resolution timer, or the common PDCCH repetition transmission is not allowed to cross the contention resolution timer;
or
the time relationship between the common PDCCH repetition transmission and a message B-response window comprises one of the following:
the common PDCCH repetition transmission is allowed to cross the message B-response window, or the common PDCCH repetition transmission is not allowed to cross the message B-response window;
or,
wherein the RAR receiving window comprises: an RAR receiving window available for the common PDCCH repetition transmission; or an RAR receiving window that is obtained after an offset is added to an RAR receiving window not available for the common PDCCH repetition transmission;
or
the message B-response window comprises:
a message B-response window available for the common PDCCH repetition transmission; or a message B-response window that is obtained after an offset is added to a message B-response window not available for the common PDCCH repetition transmission;
or
the contention resolution timer comprises:
a defined contention resolution timer available for the common PDCCH repetition transmission; or a contention resolution timer that is obtained after an offset is added to a contention resolution timer not available for the common PDCCH repetition transmission.

15. The method according to claim 1, wherein in a case that the i^{th} transmission of the common PDCCH repetition transmission and the PDSCH scheduled by the common PDCCH are in a same slot, a relationship between a starting symbol of the PDSCH scheduled by the common PDCCH and the common PDCCH repetition transmission comprises at least one of the following:
the starting symbol of the PDSCH scheduled by the common PDCCH is separated from a starting symbol of the i^{th} transmission of the common PDCCH repetition transmission by N symbols; or
the starting symbol of the PDSCH scheduled by the common PDCCH is separated from a symbol of the i^{th} transmission of the common PDCCH repetition transmission by N symbols, wherein
the value of i is equal to or greater than 1, and less than or equal to the number of repetitions of the common PDCCH, and N is greater than or equal to 0.

16. A method for processing physical downlink control channel (PDCCH) repetition transmission, comprising:
sending, by a network side device, configuration information of common PDCCH repetition transmission to a terminal; and
performing, by the network side device, the common PDCCH repetition transmission based on the configuration information, wherein
the common PDCCH comprises at least one of the following:
a system information block (SIB) 1 PDCCH, an other system information (OSI) PDCCH, a message 2 PDCCH, a message 4 PDCCH, a message B PDCCH, a paging PDCCH, or a PDCCH for scheduling message 3 retransmission.

17. The method according to claim 16, wherein the configuration information comprises at least one of the following parameters:
a function of the common PDCCH repetition transmission;
a number of repetitions of the common PDCCH repetition transmission;
an index of the common PDCCH repetition transmission;
resource information of the common PDCCH repetition transmission;
activation information of the common PDCCH repetition transmission, the activation information representing activation or deactivation of the common PDCCH repetition transmission; or
a repetition mode of the common PDCCH repetition transmission.

18. The method according to claim 16, wherein the sending, by a network side device, configuration information of common PDCCH repetition transmission to a terminal comprises:
sending, by the network side device, indication information to the terminal, the indication information being used for determining the configuration information of the common PDCCH repetition transmission, and the indication information comprising at least one of the following:
a synchronization signal block (SSB), a master information block (MIB), a physical broadcast channel (PBCH), a system information block (SIB), a radio network temporary identifier (RNTI), a control resource set (CORESET) configuration table, a monitoring occasion table of a common search space (CSS), a downlink channel receiving window, a downlink channel transmission period, a CORESET resource, a search space, a physical downlink control channel (PDCCH) monitoring occasion (MO), a physical random access channel (PRACH) resource, an SIB1 PDCCH, a message 2, a message B, a message 2 PDCCH, a message B PDCCH, a PDCCH for scheduling message 3 retransmission, radio resource control (RRC) signaling, a medium access control control element (MAC CE), a random access response, downlink control information (DCI), or a message 3.

19. The method according to claim 16, wherein the performing, by the network side device, the common PDCCH repetition transmission based on the configuration information comprises:
performing, by the network side device, the PDCCH repetition transmission based on the configuration information of the PDCCH repetition transmission and timeline information of the common PDCCH repetition transmission, the timeline information of the common PDCCH repetition transmission comprising at least one of the following:
a time sequence relationship between the common PDCCH repetition transmission and a physical downlink shared channel (PDSCH) scheduled by a common PDCCH;
a time relationship between the common PDCCH repetition transmission and an RAR receiving window;
a time relationship between the common PDCCH repetition transmission and a contention resolution timer; or
a time relationship between the common PDCCH repetition transmission and a message B-response window.

20. A terminal, comprising a processor and a memory, wherein the memory stores a program or an instruction that can be run on the processor, wherein the program or the instruction, when executed by the processor, causes the terminal to perform:
obtaining configuration information of common PDCCH repetition transmission; and
receiving the common PDCCH repetition transmission based on the configuration information, wherein
the common PDCCH comprises at least one of the following:
a system information block (SIB) 1 PDCCH, an other system information (OSI) PDCCH, a message 2 PDCCH, a message 4 PDCCH, a message B PDCCH, a paging PDCCH, or a PDCCH for scheduling message 3 retransmission.
